(19) United States
(12) Patent Application Publication
(10) Pub. No.: US 2026/0323582 A1
(43) Pub. Date: Oct. 15, 2026

(54) DEVICE-LEVEL NETWORK PERFORMANCE MATRIX

(71) Applicant: QUALCOMM Incorporated, San Diego, CA (US)

(72) Inventors: Gal IZHAKI, Haifa (IL); German David CASTANEDA, Bogotá (CO)

(21) Appl. No.: 19/551,436

(22) Filed: Feb. 26, 2026

Related U.S. Application Data
(60) Provisional application No. 63/787,244, filed on Apr. 11, 2025.

(51) Int. Cl. H04W 64/00; H04B 17/318

(52) U.S. Cl. CPC H04W 64/00; H04B 17/328

(57) ABSTRACT

This disclosure provides methods, components, devices and systems that support dynamic network configuration changes. A performance matrix combines device-level information and network-level information to support a multi-layer model of a wireless communication network on a per geographic area basis. For example, a device may obtain network information that indicates a respective set of reference signal received power (RSRP) metrics and a respective set of interference metrics for each geographic area associated with the wireless communication network. The device may additionally obtain device location information that indicates a respective quantity of devices within each geographic area associated with the wireless communication network. The device may output a set of parameters, which may be associated with the performance matrix, in accordance with the network information and the device location information.

### CROSS REFERENCES

The present application for patent claims benefit of U.S. Provisional Patent Application No. 63/787,244 by IZHAKI et al., entitled “DEVICE-LEVEL NETWORK PERFORMANCE MATRIX,” filed Apr. 11, 2025, assigned to the assignee hereof, and expressly incorporated herein.

### TECHNICAL FIELD

This disclosure relates generally to wireless communication, and more specifically to systems, devices, methods, and techniques associated with a device-level network performance matrix.

### DESCRIPTION OF THE RELATED TECHNOLOGY

Communication networks are deployed to provide communication services such as voice, video, packet data, messaging, or broadcast, among others. A communication network may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure.

One innovative aspect of the subject matter described in this disclosure can be implemented in a device. The device may include a processing system that includes processor circuitry and memory circuitry that stores code. The processing system may be configured to cause the device to obtain network information associated with a set of multiple devices within a wireless communication network, where the network information indicates a respective set of reference signal received power (RSRP) metrics and a respective set of interference metrics for each geographic area of a set of multiple geographic areas associated with the wireless communication network, obtain device location information associated with the set of multiple devices within the wireless communication network, where the device location information indicates a respective quantity of devices within each geographic area of the set of multiple geographic areas, and output a set of parameters in accordance with the network information and the device location information.

Another innovative aspect of the subject matter described in this disclosure can be implemented in a method for network communications by or at a device. The method may include obtaining network information associated with a set of multiple devices within a wireless communication network, where the network information indicates a respective set of RSRP metrics and a respective set of interference metrics for each geographic area of a set of multiple geographic areas associated with the wireless communication network, obtaining device location information associated with the set of multiple devices within the wireless communication network, where the device location information indicates a respective quantity of devices within each geographic area of the set of multiple geographic areas, and outputting a set of parameters in accordance with the network information and the device location information.

Another innovative aspect of the subject matter described in this disclosure can be implemented in a device. The device may include means for obtaining network information associated with a set of multiple devices within a wireless communication network, where the network information indicates a respective set of RSRP metrics and a respective set of interference metrics for each geographic area of a set of multiple geographic areas associated with the wireless communication network, means for obtaining device location information associated with the set of multiple devices within the wireless communication network, where the device location information indicates a respective quantity of devices within each geographic area of the set of multiple geographic areas, and means for outputting a set of parameters in accordance with the network information and the device location information.

Another innovative aspect of the subject matter described in this disclosure can be implemented in a non-transitory computer-readable medium storing code for network communications. The code may include instructions executable by a processing system to obtain network information associated with a set of multiple devices within a wireless communication network, where the network information indicates a respective set of RSRP metrics and a respective set of interference metrics for each geographic area of a set of multiple geographic areas associated with the wireless communication network, obtain device location information associated with the set of multiple devices within the wireless communication network, where the device location information indicates a respective quantity of devices within each geographic area of the set of multiple geographic areas, and output a set of parameters in accordance with the network information and the device location information.

In some implementations of the method, devices, and non-transitory computer-readable medium described herein, a first portion of the network information indicates the respective set of RSRP metrics for each geographic area of the set of multiple geographic areas and may be obtained from a first information source and a second portion of the network information indicates the respective set of interference metrics for each geographic area of the set of multiple geographic areas and may be obtained from a second information source.

In some implementations of the method, devices, and non-transitory computer-readable medium described herein, the respective set of RSRP metrics for each geographic area of the set of multiple geographic areas may be constant within a periodic cycle associated with the wireless communication network, the respective set of interference metrics for each geographic area of the set of multiple geographic areas may be variable within the periodic cycle associated with the wireless communication network, and the respective quantity of devices within each geographic area of the set of multiple geographic areas may be variable within the periodic cycle associated with the wireless communication network.

In some implementations of the method, devices, and non-transitory computer-readable medium described herein, each geographic area of the set of multiple geographic areas may be associated with a respective set of interference sources and each interference source of the respective set of interference sources may be associated with a respective interference metric of the respective set of interference metrics.

In some implementations of the method, devices, and non-transitory computer-readable medium described herein, the set of parameters may be further in accordance with a respective contribution by each interference source of the respective set of interference sources for each geographic area to an overall interference metric associated with that geographic area.

In some implementations of the method, devices, and non-transitory computer-readable medium described herein, the set of parameters includes a respective validity indication for each geographic area of the set of multiple geographic areas.

In some implementations of the method, devices, and non-transitory computer-readable medium described herein, the respective validity indication for each geographic area of the set of multiple geographic areas indicates whether that geographic area may be valid for an evaluation of the wireless communication network associated with one or more configuration changes, invalid for the evaluation of the wireless communication network associated with the one or more configuration changes, or absent of data.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communication network.

FIG. 2 shows an example antenna configuration update that supports a device-level network performance matrix.

FIG. 3 shows an example network configuration that supports a device-level network performance matrix.

FIG. 4 shows an example signaling diagram that supports a device-level network performance matrix.

FIG. 5 shows an example matrix composition of a device-level network performance matrix.

FIG. 6 shows an example geographic area-level view of a device-level network performance matrix in accordance with an example matrix composition.

FIG. 7 shows an example process flow that supports a device-level network performance matrix.

FIG. 8 shows an example network configuration change that supports a device-level network performance matrix.

FIG. 9 shows an example block diagram of an example machine learning (ML) model represented by an artificial neural network (ANN) that supports a device-level network performance matrix.

FIG. 10 shows an example block diagram of an example ML architecture that supports a device-level network performance matrix.

FIG. 11 shows a block diagram of a processing system that supports a device-level network performance matrix.

FIG. 12 shows a diagram of a system including a device that supports a device-level network performance matrix.

FIG. 13 shows a flowchart illustrating methods that support a device-level network performance matrix.

Like reference numbers and designations in the various drawings indicate like elements.

### DETAILED DESCRIPTION

A communication network may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication network (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support uses such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and uses. The systems, methods, and devices described herein may enable one or more of the foregoing technologies or new technologies or support one or more of the foregoing uses or new uses.

In some wireless communication networks, a network operator may configure a set of network parameters to control or define operation of one or more network entities within a wireless communication network. Such network parameters may include, for example, a parameter associated with a tilt of an antenna panel of a network entity, a transmit power of a cell, an azimuth of a cell, a cell border parameter, or a cell service area parameter (which may be a parameter, such as a threshold signal strength, associated with a measurement event A5 that triggers a handover from a serving cell to a neighboring cell), among other examples. Some wireless communication networks may be planned or configured with a single parameter value across an entire wireless communication network and may lack mechanisms to dynamically plan or update the parameter value. For example, in some wireless communication networks, a network parameter associated with a tilt of an antenna panel of a network entity may have a single parameter value across an entire wireless communication network, such that all network entities within the wireless communication network use the same tilt. By way of further example, a network parameter associated with a cell service area (such as associated with a measurement event A5) may have a single parameter value across at least a majority of the wireless communication network or across at least a majority of cells in a given frequency, such that at least a majority of network entities or cells within the wireless communication network use the same cell service area. Such a static configuration of some network parameters may result in a degraded user experience (such as low throughput, coverage gaps, or radio link failures (RLFs)) at some user equipment (UEs) and may result in a network operator being unable to change a configuration of the wireless communication network to adapt to changing RF conditions. Further, even in wireless communication networks that support mechanisms for dynamically changing a network configuration, some network operators may lack a comprehensive way of predicting an effectiveness of a network configuration change (such as throughout a portion or an entirety of a wireless communication network), which may similarly result in degraded user experience in some scenarios. For example, a mobile network operator may inadvertently or unknowingly (at least before the change occurs) cause user experience degradation for some users due to inaccurately predicting (or being unable to predict) an overall user experience impact from a network configuration change (throughout the portion or the entirety of the wireless communication network).

Various aspects of the subject matter described in this disclosure relate to a device-level network performance matrix that supports dynamic network configuration changes. Some aspects more specifically relate to a composition of the device-level network performance matrix and how the device-level network performance matrix enables an evaluation of an impact from a network configuration change throughout a wireless communication network. In some implementations, the device-level network performance matrix combines device-level information and network-level information to support a multi-layer model of the wireless communication network on a geographic area basis. For example, a server device (among other example devices) may partition a wireless communication network into multiple geographic areas (such as tiles) and, as part of constructing the device-level network performance matrix, may obtain (such as receive, calculate, retrieve, select, predict, or otherwise determine) network information and device location information. The network information may indicate a respective set of reference signal received power (RSRP) metrics and a respective set of interference metrics for each geographic area associated with the wireless communication network. The respective set of RSRP metrics may include an RSRP metric associated with a serving cell for that geographic area and one or more RSRP metrics associated with one or more interference sources for that geographic area. The respective set of interference metrics may include one or more interference metrics (such as a traffic load) associated with the one or more interference sources for that geographic area.

The device location information may indicate a respective quantity of devices (such as UEs) within each geographic area associated with the wireless communication network. The device location information may indicate the respective quantity of devices within each geographic area explicitly (via one or more numeric values) or implicitly (via an association, a representation, or a correlation). For example, the device location information may indicate a respective traffic load within each geographic area, which may be representative of or correlated with a quantity of devices within that geographic area. The respective traffic load within each geographic area may be denoted in units of a quantity of megabits (or any bit or data rate) or a percentage of utilized physical resource blocks (PRBs). A traffic load within a geographic area may pertain to downlink traffic, uplink traffic, or both downlink and uplink traffic. The quantity of devices within a geographic area may include a quantity of devices with a radio resource control (RRC) connection to one or more network entities or a quantity of scheduled devices (such as devices with an uplink or downlink resource allocation). In other words, the device location information may indicate any metrics that provide a network operator with an understanding of an “intensity” (such as a “user intensity”) of each geographic area, with such an intensity pertaining to how impactful a change in that geographic area might be relative to a change in another geographic area.

In some implementations, the server device may output (such as transmit, send, generate, construct, compose, or otherwise provide) the device-level network performance matrix in accordance with the network information and the device location information. The server device may output the device-level network performance matrix, which may be associated with a model of the wireless communication network, as or via a set of parameters, which may be understood or otherwise referred to as matrix or model parameters. In some implementations, the server device may output the device-level network performance matrix to a network operator, and the network operator may use the device-level network performance matrix to evaluate an impact throughout (at least a portion of) the wireless communication network from one or more network configuration changes. The evaluation may be associated with a performance indicator metric (such as a signal-to-interference-plus-noise ratio (SINR), a channel quality indicator (CQI), or any other quality or metric that is representative of a performance indicator, such as a reference signal received quality (RSRQ), a block error rate (BLER), or a packet loss) calculation and a conversion from the performance indicator metric (such as the SINR, the CQI, the RSRQ, the BLER, or the packet loss) to throughput or user experience (or any other performance indicator associated with network performance). In some implementations, the RSRP metrics may correspond to an approximately constant component of an SINR calculation, and the interference metrics may correspond to a dynamic (such as variable) component of the SINR calculation, such that the device-level network performance matrix may provide the network operator with a comprehensive understanding of both constant and dynamic components of SINR to evaluate a network configuration change. Further, in some implementations, the server device may output a respective validity indication for each geographic area associated with the wireless communication network, which may indicate whether that geographic area is valid or invalid for the evaluation.

Particular aspects of the subject matter described in this disclosure can be implemented to realize one or more of the following potential advantages. In some implementations, by accounting for both constant and dynamic components of SINR via the network information and a quantity of impacted devices via the device location information, the device-level network performance matrix that the server device provides to the network operator may facilitate a more accurate evaluation of an overall network impact from one or more simulated network configuration changes. A more accurate evaluation of the overall network impact may support network planning decisions that more consistently achieve a target or goal (such as to increase user throughput) without inadvertent consequences elsewhere in the network. Further, by indicating a respective validity indication for each geographic area associated with the wireless communication network, the server device may extend a use of the device-level network performance matrix to a larger range of scenarios without over-confidence, including scenarios in which the server device is still actively acquiring additional information for refinement of the device-level network performance matrix. By extending a use of the device-level network performance matrix to a larger range of scenarios without over-confidence, the server device may guide use of the device-level network performance matrix by the network operator and mitigate scenarios in which network planning decisions are made using results for a geographic area for which the device-level network performance matrix has insufficient information. In accordance with performing network planning decisions that account for the network information, the device location information, and the validity information, the network operator may implement network configuration changes that provide greater coverage, higher data rates, and greater reliability at least for areas with the most users, among other benefits.

Further, in some implementations, the server device or the network operator may simulate any network or cell configuration change (such as a change associated with a transmit power, an antenna configuration (such as tilt, azimuth, antenna profile), or other network parameters that set a border of a cell (such as A5 or B2)) using the device-level network performance matrix to predict (such as identify, calculate, estimate, ascertain, or otherwise determine) an RSRP impact in a geographic area level granularity, with each geographic area encompassing user intensity information. Moreover, the server device or the network operator may perform such predications at any time scale (such as per hour) considering a corresponding load or interference and a quantity of users at each of various times (such as at a specific hour) such that an overall performance assessment is assessed from the device (such as UE) perspective in a target granularity (such as for each geographic area per hour). In other words, the device-level network performance matrix provides, in addition to a cell level assessment (which may be performed using one or more of various techniques associated with cell measurement) of one or more key performance indicators (KPIs) (such as SINR or CQI and throughput, among any other qualities or metrics that may be representative of one or more KPIs, such as RSRQ, BLER, or packet loss), a device level assessment measured as an aggregation of geographic areas that are impacted by a network or cell configuration change. Such a device level assessment in a geographic area level view may, for each geographic area (that is impacted by the network or cell configuration change), be associated with an assessment of an intensity of that geographic area (such as the quantity of users or devices within that geographic area), an assessment of a performance indicator metric (such as an SINR, a CQI, or any other quality or metric that is representative of a performance indicator, such as an RSRQ, a BLER, or a packet loss) increase or decrease (which may be translated to throughput), and an evaluation of a weighted performance indicator metric after the network or cell configuration change from the device perspective, which may provide a greater granularity and facilitate more accurate predictions as compared to other techniques associated with cell performance assessment.

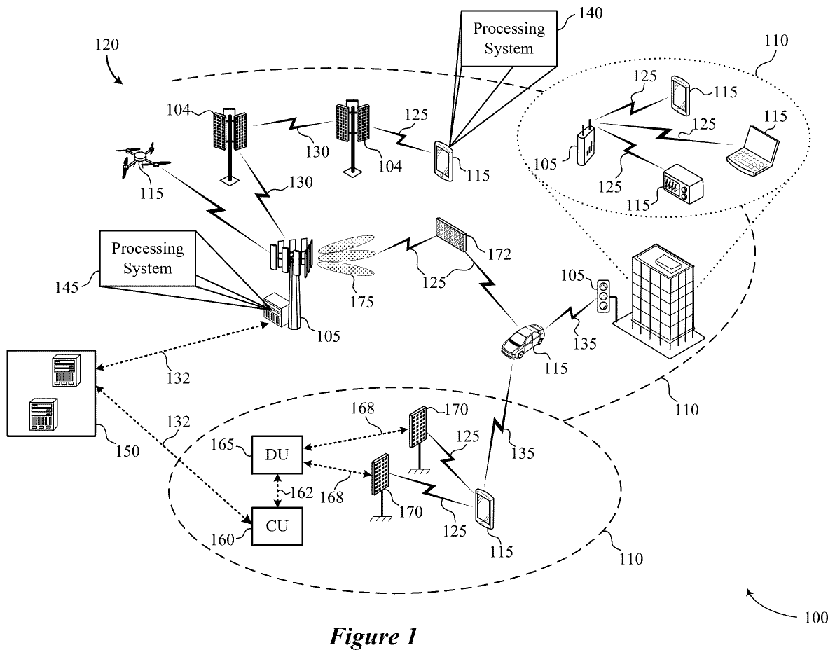

FIG. 1 shows an example wireless communication network 100. The wireless communication network 100 includes a core network 150 and a RAN 120 that support communication with one or more devices, such as UEs 115. A RAN 120 may include one or more network entities 105 configured to support wireless communication with the UEs 115.

The wireless communication network 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication network 100 may include a heterogeneous network in which different types of network entities 105 support communication for one or more coverage areas 110 using the same or different RATs.

In some implementations, a network entity 105 may be implemented in an aggregated (such as monolithic, standalone) architecture, which may utilize a protocol stack that is physically or logically integrated within one network entity 105 (such as a single physical RAN node). In some other implementations, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication network 100 also may implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication network 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication network 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication network 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication network 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a PRB, may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication network 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication network 100 may be configured to support one or more aspects of the described techniques for a device-level network performance matrix. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication network 100 (such as the RAN 120) may support network configuration changes (such as network configuration updates) in accordance with a device-level network performance matrix (such as in accordance with a model of the wireless communication network 100 that is associated with both device-level information and network-level information).

For example, a server device (among other example devices) associated with the wireless communication network 100 may combine device-level information and network-level information to support a multi-layer model of the wireless communication network 100 and may output parameters associated with the multi-layer model to a network operator (such as a mobile network operator), which may simulate a network impact of one or more network configuration changes using the parameters associated with the multi-layer model. In some implementations, the server device may determine, generate, build, construct, compose, or otherwise calculate the device-level network performance matrix (the multi-layer model) to facilitate a performance evaluation of the wireless communication network 100 on a per geographic area basis. Further, although some aspects are illustrated and described in the example of cellular communication between various devices or nodes, the described techniques may be implemented using any wireless communication technology including, for example, Wi-Fi. For example, a user device (such as a UE 115) may upload data (such as device management and analytics platform (DMAP) data) to the server device or another device (for provision to the server device) via a Wi-Fi connection or via a cellular connection.

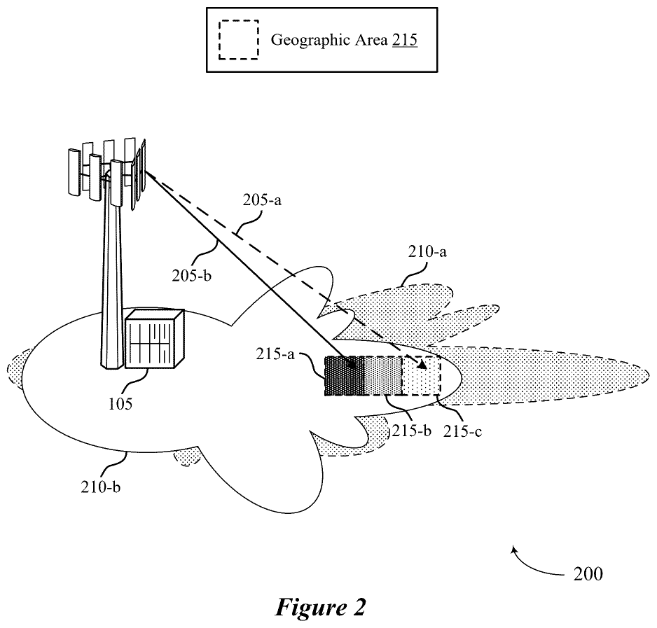

FIG. 2 shows an example antenna configuration update 200 that supports a device-level network performance matrix. A network entity 105, which may be an example of a network entity 105 as described with reference to FIG. 1, may perform the antenna configuration update 200. In some implementations, an operator (such as a mobile network operator) of a wireless communication network may perform the antenna configuration update 200 to update one or more antenna configuration parameters at one or more network entities 105 within the wireless communication network. In some implementations, a network entity 105 may receive a request to update an antenna configuration parameter via or from an operation system.

The update to the antenna configuration parameter may include a down-tilt for the antenna configuration at the network entity 105. For example, the network entity 105 may include a set of antennas (such as an antenna panel, a set of antenna ports, a set of antenna elements, or an antenna array) with an angle of transmission 205-a. The network entity 105 may decrease (such as down-tilt) the angle of transmission for the set of antennas from the angle of transmission 205-a to the angle of transmission 205-b in accordance with the update to the antenna configuration parameter. Alternatively, the update to the antenna configuration parameter may include an up-tilt for the antenna configuration at the network entity 105. For example, the network entity 105 may increase (such as up-tilt) the angle of transmission for the set of antennas from the angle of transmission 205-b to the angle of transmission 205-a in accordance with the update to the antenna configuration parameter. Additionally, or alternatively, the update to the antenna configuration parameter may update any other antenna configuration parameters, such as a transmit power, an antenna profile, an antenna azimuth, an antenna type (such as a passive antenna or an active antenna, such as an active antenna using massive MIMO), or any combination thereof.

In some implementations, the service or platform (such as the DMAP) may calculate (such as determine, identify, select, track, estimate, predict, or otherwise ascertain) a signal strength map for the network entity 105 or for a set of network entities 105 including the network entity 105. In some implementations, the signal strength map may be an example of a multi-dimensional (such as three-dimensional (3D)) signal strength map. The service or platform may determine (such as calculate, estimate, predict, or otherwise ascertain) a first signal strength map 210-a associated with the current antenna configuration at the network entity 105 and may determine (such as calculate, estimate, predict, or otherwise ascertain) a second signal strength map 210-b associated with the updated antenna configuration at the network entity 105. An RSRP metric may be an example of a signal strength metric.

The service or platform may additionally, or alternatively, calculate (such as determine, identify, select, track, estimate, predict, or otherwise ascertain) an impact of the antenna configuration update 200 on one or more geographic areas 215. A geographic area 215 may be an example of a unit of area within the wireless network. The geographic areas 215 may segment the coverage area of the wireless network to track granular information about the wireless network. For example, the service or platform may calculate (such as determine, identify, select, track, estimate, predict, or otherwise ascertain) how switching from the first angle of transmission 205-a to the second angle of transmission 205-b affects average signal strength (such as in dBs, or in dBms) at the geographic area 215. In some implementations, the service or platform may calculate (such as determine, identify, select, track, estimate, predict, or otherwise ascertain) the impact of the antenna configuration update 200 on one or more vertical tiles, one or more horizontal tiles, or some combination thereof. For example, switching from the first angle of transmission 205-a to the second angle of transmission 205-b may increase an average signal strength at the geographic area 215-a, relatively maintain an average signal strength at the geographic area 215-b, and decrease an average signal strength at the geographic area 215-c. Such an antenna configuration update 200 may reduce the ability of the network entity 105 to over-shoot coverage, reducing the likelihood that the network entity 105 operates as an interferer for a geographic area. Further, in accordance with some example implementations, the antenna configuration update 200 may account for a calculation for all geographic areas 215 that may be impacted by the antenna configuration update 200 (such that the antenna configuration update 200 may be performed in accordance with previously predicting a geographic area level performance after the antenna configuration update 200).

In some implementations, a device (such as a server device) may obtain information from the service or platform (such as the DMAP) indicative of the signal strength map. The device may obtain the information from the service or platform as network information that indicates, for example, a respective set of RSRPs for each of multiple geographic areas 215. The device may combine such information with other information, such as other network information, device location information, or any combination thereof. In accordance with such information, which the device may obtain from one or more of various information sources, the device may generate (such as construct, compose, calculate, build, or otherwise determine) a device-level network performance matrix (such as a model associated with the wireless communication network including the network entity 105) and output a set of parameters (such as a set of matrix or model parameters) associated with the device-level network performance matrix to an operator of the wireless communication network or one or more applications associated with network planning or modeling, or both. In other words, the device may output the device-level network performance matrix to the network operator, the core network, the network entity 105, or any other device associated with one or more applications (such as an operator application or a third-party application, among other example applications) that may evaluate various hypothetical scenarios using the device-level network performance matrix. For example, the device or entity that obtains the device-level network performance matrix (via, for example, the set of matrix or model parameters) may use the device-level network performance matrix to evaluate a network impact from one or more network configuration changes, such as the antenna configuration update 200.

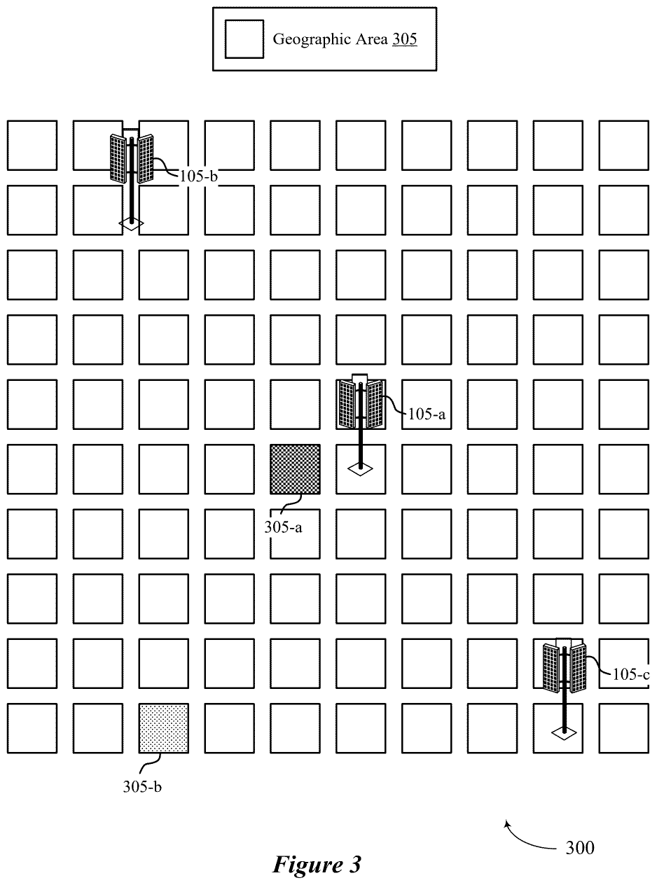

FIG. 3 shows an example wireless communication network 300 that supports a device-level network performance matrix. The wireless communication network 300 may include a network entity 105-a, a network entity 105-b, and a network entity 105-c, each of which may be an example of a network entity 105 as illustrated by and described with reference to FIGS. 1 and 2.

The wireless communication network 300 may be associated with geographic areas 305, which may be understood as geographic tiles, segments, spaces, sectors, zones, or portions of the wireless communication network 300. Each geographic area 305 may be defined by a length and a width. For example, each geographic area 305 may be defined by a length of X meters and a width of Y meters, with X and Y being the same or different. By way of further example, each geographic area 305 may be a square of 6 meters by 6 meters or of 60 meters by 60 meters, or of any other length and width. A size of each geographic areas 305 may be constant over time or may vary over time. For example, a size of each geographic areas 305 may be relatively larger at a first time (such as to increase a likelihood of obtaining a threshold amount of information associated with each geographic areas 305) and may be relatively smaller at a second time (such as after a confidence in obtaining the threshold amount of information associated with each geographic area 305 satisfies a threshold confidence). In some aspects, each geographic area 305 associated with the wireless communication network 300 may have a size same. In some other aspects, the geographic areas 305 may vary in size (such that a first geographic area 305 is larger or smaller than a second geographic area 305).

In some implementations, including implementations in which the geographic areas 305 are associated with a 3D virtual representation of the wireless communication network 300 (such as associated with a digital twin of the wireless communication network 300), each geographic area 305 may further be defined by a height. For example, different geographic areas 305 may be located at different heights within the wireless communication network 300, such as to simulate or approximate different elevations (such as different floors of a building, such as height above a ground floor for indoor deployment scenarios) within the wireless communication network 300. Further, although illustrated in the examples of FIG. 3 as being two dimensional (2D) and described herein as an “area,” the geographic areas 305 may denote or be associated with 3D spaces or portions of the (3D virtual representation of) the wireless communication network 300.

One or more devices or entities associated with network planning for the wireless communication network 300 may support a device-level network performance matrix associated with the wireless communication network 300, which may account for (such as be associated with, factor in, or otherwise be in accordance with) device-level information and network-level information to provide, facilitate, enable, generate, correspond to, or otherwise output a network model associated with the wireless communication network 300. Such a network model may be understood as a multi-layer model by being in accordance with device-level information (which may be understood as a first layer of the network model) and network-level information (which may be understood as a second layer of the network model). The multi-layer model may be associated with, derived from, or equivalently referred to as the device-level network performance matrix.

The multi-layer model may enable precise impact predication of one or more network configuration changes within the wireless communication network. In other words, one or more devices or entities associated with network planning for the wireless communication network 300 may leverage, employ, utilize, or otherwise use the multi-layer model to predict a user perspective impact from a network configuration change. In accordance with enabling a prediction of a user perspective impact from a network configuration change, the one or more devices or entities associated with the network planning for the wireless communication network 300 may perform a dynamic network configuration to drive (such as result in or increase a likelihood of) greater user experience throughout the wireless communication network 300.

In some implementations, one or more devices or entities associated with network planning for the wireless communication network 300 may use the multi-layer model to predict a user experience impact from a network configuration change at each geographic area 305 associated with the wireless communication network 300. Such a network configuration change may include an antenna configuration change (such as the antenna configuration update 200 illustrated by and described with reference to FIG. 2) at one or more of the network entity 105-a, the network entity 105-b, or the network entity 105-c, a network parameter change at one or more of the network entity 105-a, the network entity 105-b, or the network entity 105-c, a new site (such as a newly added network entity 105, such as in addition to one or more of the network entity 105-a, the network entity 105-b, or the network entity 105-c), or a site removal, among other examples. The multi-layer model may enable an aggregation of a single network configuration change to multiple network configuration changes.

Further, by predicting the user experience impact at each geographic area 305, the multi-layer model may enable an aggregation of a predicted impact from a single geographic area 305 to multiple geographic areas 305 (such as to all impacted geographic areas 305), and may account for a quantity of impacted devices (such as users or UEs 115) per geographic area 305 by obtaining information indicative of a quantity of devices (or a traffic volume in downlink or uplink, a PRB utilization in downlink or uplink, or any other counter, metric, or KPI, or any combination thereof, that may be representative of a magnitude of the users or the data generated by the users) within each geographic area 305. In such implementations, one or more devices or entities associated with network planning for the wireless communication network 300 may use the multi-layer model to predict an impact of a network configuration change with a quantity of impacted devices per geographic area 305 and with their corresponding throughput. For example, the one or more devices or entities associated with the network planning for the wireless communication network 300 may use the multi-layer model to predict a first impact (such as to user experience, such as via one or both of an SINR or CQI (or any other quality or metric that is representative of a performance indicator) calculation or a throughput calculation (or any other performance indicator associated with network performance)) to a first set of one or more devices within a first geographic area 305-a and a second impact to a second set of one or more devices within a second geographic area 305-b. The first impact, the second impact, or both may be associated with (such as indicated by, defined by, or correlated with) one or more performance indicator metrics. A performance indicator metric, which may be any quality or metric that is representative of a performance indicator, may be or indicate at least one of an SINR, a CQI, a throughput, an RSRQ, a BLER, or a packet loss. In examples in which the first set of one or more devices located within the first geographic area 305-a includes a greater quantity of devices as compared to the second set of one or more devices located within the second geographic area 305-b, the one or more devices or entities associated with the network planning for the wireless communication network 300 may use the multi-layer model to prioritize a positive user experience impact at the first geographic area 305-a. In other words, the multi-layer model (such as the device-level network performance matrix) may give a greater weight to a geographic area with a relatively higher user intensity and, in some implementations, may calculate an aggregated score (such as an aggregated KPI score) over a set of (such as all) geographic areas that are impacted by a network configuration change (in association with weighting different geographic areas using their respective user intensity levels).

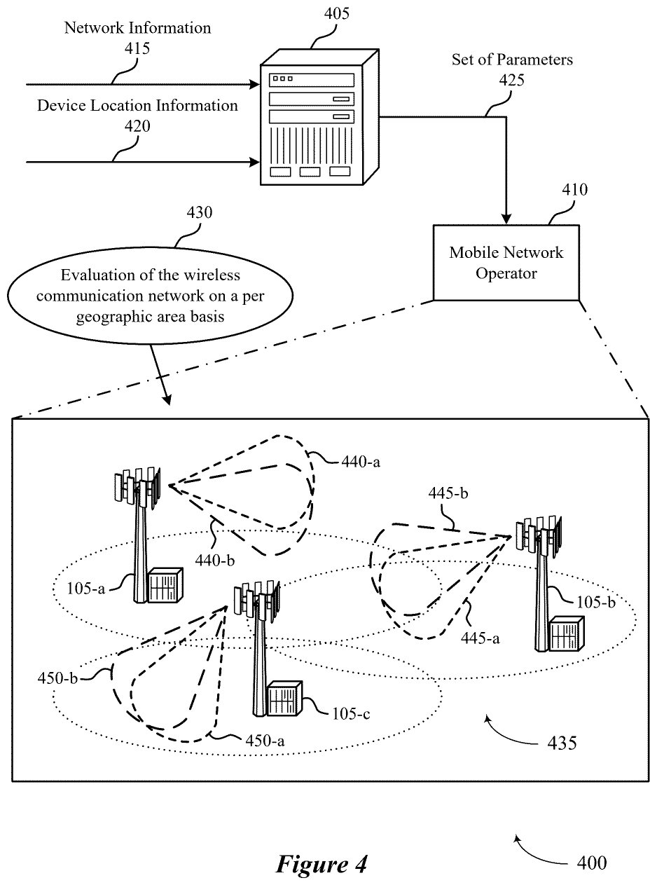

FIG. 4 shows an example signaling diagram 400 that supports a device-level network performance matrix. The signaling diagram 400 illustrates signaling between a server device 405 and one or more devices or entities associated with network planning for a wireless communication network (such as the wireless communication network 100 or the wireless communication network 300), collectively illustrated and described as a mobile network operator 410. The server device 405 may be any type of device capable of obtaining device-level information and network-level information and outputting (such as generating, composing, or providing) a multi-layer model in accordance with the obtained information. In some implementations, the server device 405 may output the multi-layer model to the mobile network operator 410 as a service, such as in accordance with a subscription by the mobile network operator 410 associated with the multi-layer model.

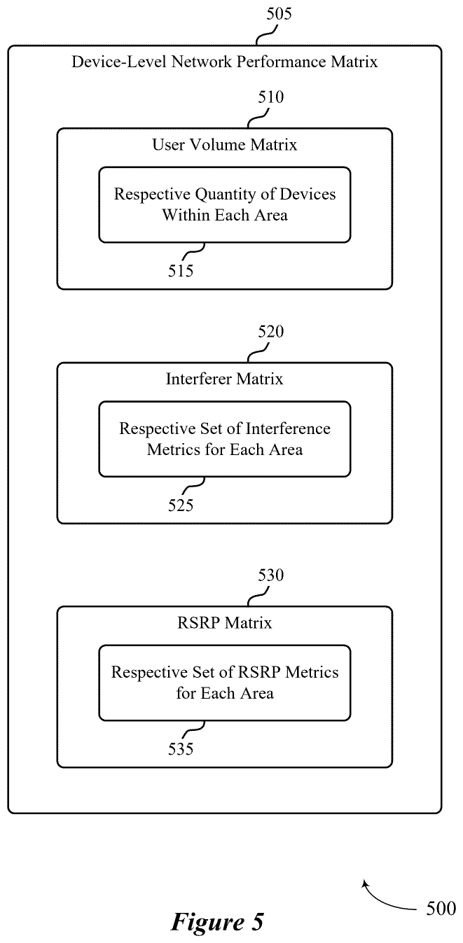

In some implementations, the server device 405 may receive network information 415 and device location information 420. The network information 415 may indicate a respective set of RSRP metrics and a respective set of interference metrics for each geographic area associated with a wireless communication network (such as for each geographic area 305 associated with the wireless communication network 300, as illustrated by and described with reference to FIG. 3). The device location information 420 may indicate a respective quantity of devices (such as UEs 115) within each geographic area of the wireless communication network (such as for each geographic area 305 associated with the wireless communication network 300, as illustrated by and described with reference to FIG. 3). The server device 405 may obtain the network information 415 and the device location information 420 from one or more of various information sources, as described in more detail herein, including with reference to FIG. 5.

In accordance with obtaining the network information 415 and the device location information 420, the server device 405 may output a set of parameters 425, such as a set of matrix or model parameters. The set of parameters 425 may be (generated, determined, identified, or selected) in accordance with the network information 415 and the device location information 420. In some implementations, the set of parameters 425 may be associated with (such as indicative of) a model 435 of the wireless communication network (such as the wireless communication network 300). In other words, the set of parameters 425 may provide the model 435 to the mobile network operator 410. Such a model 435 of the wireless communication network may be a multi-layer model, such as the multi-layer model described with reference to FIG. 3. For example, the model 435 may be an example of or may otherwise be associated with a device-level network performance matrix. In such examples, the set of parameters 425 may be or may provide the device-level network performance matrix.

In some implementations, the server device 405 may output the model 435 to the mobile network operator 410 via the set of parameters 425. Additionally, or alternatively, the server device 405 may output the set of parameters 425 to the mobile network operator 410 to enable the mobile network operator 410 to generate or construct the model 435. Additionally, or alternatively, the server device 405 may output the set of parameters 425 to the mobile network operator 410 to enable the mobile network operator 410 to update or refine the model 435. Further, although illustrated and described in the example scenario of the server device 405 outputting the set of parameters 425 to the mobile network operator 410, the server device 405 may additionally, or alternatively, output the set of parameters 425 to another device, node, or entity, such as other consumers within or otherwise associated with one or more operator organizations.

The mobile network operator 410 may perform an evaluation 430 of the wireless communication network on a per geographic area basis in accordance with the set of parameters 425 (such as in accordance with the model 435). For example, the mobile network operator 410 may perform the evaluation 430 of the wireless communication network to mitigate, and potentially resolve, a network weak spot. In accordance with the set of parameters 425 being in accordance with the network information 415 and the device location information 420, the evaluation 430 may be in accordance with the respective set of RSRP metrics for each geographic area, the respective set of interference metrics for each geographic area, and the respective quantity of devices within each geographic area. In some implementations, the evaluation 430 includes a calculation of a respective performance indicator metric (such as SINR, CQI, or any other quality or metric that is representative of a performance indicator, such as RSRQ, BLER, or packet loss) for each geographic area associated with the wireless communication network (with the respective performance indicator metric for each geographic area being associated with a respective throughput, or any other performance indicator associated with network performance, for that geographic area). Additionally, or alternatively, the evaluation 430 may include a prediction of a user experience impact from one or more network configuration changes to the wireless communication network (with one or more of the respective set of RSRP metrics, the respective SINR or CQI (or any other quality or metric that is representative of a performance indicator metric), or the respective throughput (or any other performance indicator metric associated with network performance) for each geographic area being indicative of a respective user experience within that geographic area). A performance indicator metric may be or indicate at least one of an SINR, a CQI, a throughput, an RSRQ, a BLER, or a packet loss.

A network configuration change to the wireless communication network may include an antenna configuration change, another network parameter change, a new site, a site removal, or any combination thereof, among any other example network configuration changes that might impact RSRP of one or more devices within the wireless communication network. For example, an antenna configuration change may include switching, at the network entity 105-a, from a first angle of transmission 440-a to a second angle of transmission 440-b (in accordance with tilting, rotating, or otherwise updating a configuration of one or more antennas, antenna arrays, or antenna panels of the network entity 105-a). Additionally, or alternatively, the antenna configuration change may include switching, at the network entity 105-b, from a first angle of transmission 445-a to a second angle of transmission 445-b (in accordance with tilting, rotating, or otherwise updating a configuration of one or more antennas, antenna arrays, or antenna panels of the network entity 105-b). Additionally, or alternatively, the antenna configuration change may include switching, at the network entity 105-c, from a first angle of transmission 450-a to a second angle of transmission 450-b (in accordance with tilting, rotating, or otherwise updating a configuration of one or more antennas, antenna arrays, or antenna panels of the network entity 105-c).

By way of further example, another network parameter change may include changing (at any one or more of the network entity 105-a, the network entity 105-b, or the network entity 105-c) one or more transmission power parameters, one or more parameters associated with establishing one or more cell borders (such as cell edges) or one or more handover locations (such as one or more of event A5, B2, A6, CIO, or offset parameters), one or more carrier aggregation parameters (such as A2 or A4), or one or more traffic steering parameters (such as a threshold serving low/high (which may be denoted as ThreshSrvLow/ThreshSrvHigh) or a threshold×low/high (which may be denoted as ThreshXLow/ThreshXHigh), among other parameters (such as SnonIntersearch (a parameter associated with a time at which a UE 115 starts an inter-radio access technology (RAT) measurement) or Qrxlevmin (a parameter indicating, for cell selection or re-selection, a minimum or lower limit received RSRP level)), which may be idle parameters that may be determined or concluded from one or more active parameters (such as A5 and B2 parameters, among others), with the one or more active parameters being derived from the device-level network performance matrix) among other example parameters that impact network operation or that impact one or more cell coverage areas. In other words, a network parameter change may include a change or update to any parameter of any infrastructure vendor type that has an impact on one or more cell coverage areas in idle, active, or both. By way of further example, a new site may include adding another network entity 105 to the wireless communication network. By way of further example, a site removal may include removing one or more of the network entity 105-a, the network entity 105-b, or the network entity 105-c from the wireless communication network.

The evaluation 430 may include an analysis of an impact from one or more network configuration changes with an analysis granularity on a geographic area level, such as to predict an impact of one or more network configuration changes on one or more performance indicator metrics (such as SINR, CQI, or any other quality or metric that is representative of a performance indicator including, for example, RSRQ, BLER, or packet loss (per geographic area)). In some implementations, a device (such as UE 115) modem may capture (such as measure, calculate, or otherwise determine) a serving cell SINR or CQI, an RSRP, or an RSRQ (or any other quality or metric that is representative of a performance indicator, such as a BLER or a packet loss) and may capture (such as measure, calculate, or otherwise determine) an RSRP of one or more neighbor cells (cells that the device may perform a handover to) or of one or more detected cells (interfering cells that the device may be unable to perform a handover to but still received or measured as interferers). In some aspects, the device modem may calculate an SINR in accordance with Equation 1, shown below. The SINR formula shown by Equation 1 is in accordance with the definition of SINR as set forth by the 3GPP standards organization.

$$SIN R = \frac{S}{I + N} = \frac{Serving\_RSRP \_CRS}{Noise + Interference\_on \_CRS \_Tones} \qquad ( 1 )$$

In Equation 1, S denotes a measured signal strength, I denotes a measured interference, and N denotes a measured noise. The device modem may use, for the measured signal strength, an RSRP of a serving cell on a set of one or more cell-specific reference signal (CRS) tones (or any other tones, such as subcarriers, via which the device may receive a reference signal from the serving cell). The device modem may use, for the measured interference, an interference (a received power) measured on the set of one or more CRS tones of the serving cell (or any other tones, such as subcarriers, via which the device may receive and measure interfering signaling).

In accordance with the set of parameters 425, an evaluation 430 associated with executing a network configuration change may account for both a respective serving cell and a respective set of one or more interference sources (such as interfering cells) for each geographic area associated with the wireless communication network and, in accordance with such accounting, may include a calculation of a new performance indicator metric (such as a new SINR, CQI, or any other quality or metric that is representative of a performance indicator, such as RSRQ, BLER, or packet loss) for each geographic area. To calculate the new performance indicator metric for each geographic area, the set of parameters 425 (and, likewise, the evaluation 430 and the model 435) may be in accordance with a separation of/(the interference component of SINR) into multiple constituent components, each constituent component corresponding to a respective interference source of the respective set of one or more interference sources for that geographic area. Such a constituent component (an interferer component) may be the interference on serving cell CRS tones or any other tones via which a device may receive a reference signal from a serving cell. For example, the set of parameters 425 (and the evaluation 430 and the model 435) may be in accordance with or facilitate a calculation of SINR per Equation 2, shown below.

$$SIN R = \frac{Serving\_RSRP \_CRS}{Noise + Inter 1 + Inter 2 + Inter 3 + Inter 4 …} \qquad ( 2 )$$

The server device 405 may separate the interference into the multiple constituent components in accordance with a device modem capturing the interferers' RSRP but being unable to capture a respective interference level of each one of the interferers on the serving cell CRS tones. In some aspects, the server device 405 may assume that noise (N) is constant. In the example of Equation 2, the I component of SINR is separated into multiple constituent components including a first interference from a first interference source Inter 1, a second interference from a second interference source Inter 2, a third interference source from a third interference source Inter 3, and so on. There may be any quantity of interference sources for a given geographic area, such as 1 interference source, 2 interference sources, 3 interference sources, or any other numeric value of interference sources. Each constituent component of the interference may be from a neighbor cell reference signal (such as CRS) transmission or a neighbor cell data transmission (such as a physical downlink shared channel (PDSCH) transmission). A contribution by that constituent component of the interference to the overall interference may be associated with (such as depend on) whether that constituent component is from a neighbor cell reference signal transmission or from a neighbor cell data transmission, or from a combination of both.

In other words, and more generally, a contribution by that constituent component of the interference to the overall interference may be associated with (such as depend on) whether an interference source for that constituent component satisfies a condition. The contribution may be a full contribution or a partial contribution, relative to a transmission power at the interference source. For example, in scenarios in which an interference source uses a same set of tones (such as a same set of CRS tones) for a reference signal transmission as a serving cell for a given geographic area, the set of parameters 425 (and the evaluation 430 and the model 435) may be in accordance with a full interference contribution by the interference source for the given geographic area. In scenarios in which an interference source uses a different set of tones (such as a different set of CRS tones) for a reference signal transmission than a serving cell for a given geographic area, the set of parameters 425 (and the evaluation 430 and the model 435) may be in accordance with a partial interference contribution by the interference source for the given geographic area.

In some implementations, the server device 405 may generate the set of parameters 425 (such as the device-level network performance matrix) in accordance with determining (such as identifying, selecting, predicting, ascertaining, or calculating), for each interference source of a set of interference sources for a given geographic area, whether that interference source provides a full interference contribution or a partial interference contribution. In some implementations, the server device 405 may determine whether an interference source provides a full interference contribution or a partial interference contribution in accordance with a cell ID (such as a physical cell ID (PCI)) of the interference source and a cell ID of a serving cell for a given geographic area. For example, if the cell IDs of the interference source and the serving cell are modulo 3 (among other examples, such as modulo 6) relative to each other, the server device 405 may classify the interference source as providing a full interference contribution (as such an operation may indicate that the interference source and the serving cell use a same set of CRS tones). Alternatively, if the cell IDs of the interference source and the serving cell are not modulo 3 (among other examples, such as modulo 6) relative to each other, the server device 405 may classify the interference source as providing a partial interference contribution (as such an operation may indicate that the interference source and the serving cell use different sets of CRS tones).

In examples in which an interference source is classified as providing a full interference contribution to devices within a geographic area, the set of parameters 425 (and the evaluation 430 and the model 435) may be in accordance with use of a full value of an interferer RSRP as part of calculating a new performance indicator metric (such as a new SINR, CQI, or any other quality or metric that is representative of a performance indicator, such as RSRQ, BLER, or packet loss) for the geographic area. In such examples, in scenarios in which one or more hypothetical network configuration changes results in a neighbor cell power reduction by X dB, the mobile network operator 410 may use the interferer RSRP as is and reduce by X dB (to calculate a performance indicator metric such as an SINR, CQI, or any other quality or metric that is representative of a performance indicator, such as an RSRQ, a BLER, or a packet loss). By way of example, X=4 and the mobile network operator 410 may reduce the interferer RSRP by 4 dB for the geographic area in accordance with the interference source being classified as providing a full interference contribution for the geographic area.

Alternatively, in examples in which an interference source is classified as providing a partial interference contribution to devices within a geographic area, the set of parameters 425 (and the evaluation 430 and the model 435) may be in accordance with use of a fraction of an interferer RSRP as part of calculating a new performance indicator metric (such as a new SINR, CQI, or any other quality or metric that is representative of a performance indicator, such as RSRQ, BLER, or packet loss) for the geographic area. In such examples, the mobile network operator 410 may use a multiplier value (of less than 1) to calculate the interferer RSRP fraction. The multiplier value may be associated with a load (such as a traffic load, such as a downlink PRB utilization) at the interference source or a Pa Pb value (such as one or more of a Pa value and a Pb value) at the interference source, or both. A Pa Pb value may include one or more values associated with a transmission power at the interference source, such as associated with (indicative of) a delta between a transmission power for data (such as PDSCH) and a transmission power for reference signals. For example, an interferer RSRP fraction may be calculated in accordance with Equation 3, shown below.

$$Interferer RSRP Fraction = Interferer RSRP * Interferer Load * Pa Pb \qquad ( 3 )$$

In the example of Equation 3, the multiplier value may be equal to Interferer Load*Pa Pb. In other words, multiplier values may be associated with, such as dependent on, an allocation or a loading, or both, of a neighbor cell (such as an interference source). For example, one or more hypothetical network configuration changes may result in a neighbor cell power reduction by X dB, which may result in a new interferer RSRP value X′ dBm. In such examples, the mobile network operator 410 may multiply X′ dBm by a multiplier value Y (to calculate a performance indicator metric such as an SINR, CQI, or any other quality or metric that is representative of a performance indicator, such as an RSRQ, a BLER, or a packet loss) for a geographic area. The multiplier value Y may be equal to Interferer Load*Pa Pb. For example, a device (such as the mobile network operator 410) may calculate a load in dB and a Pa Pb value in dB, sum the load and the Pa Pb value in dB, and subtract the sum of the load and the Pa Pb value from the new RSRP (such as X′) in dBm. A device (such as the mobile network operator 410) may obtain information indicative of a cell load or a cell configuration of Pa Pb (to calculate a PDSCH power in comparison to RSRP) from the network or via the set of parameters 425, or both. Additionally, or alternatively, the server device 405 may obtain information indicative of a cell load or a cell configuration of Pa Pb and construct the set of parameters 425 (such as the device-level network performance matrix) in accordance with such information. In such implementations, the calculation of the interferer power (such as the interferer RSRP fraction) may be incorporated into the device-level network performance matrix, such that the mobile network operator 410 may run simulations of one or more hypothetical network configuration changes in accordance with the interferer power calculation for each interferer by using the device-level network performance matrix.

In accordance with Equation 2, the mobile network operator 410 may use a serving cell RSRP change as is (to calculate a performance indicator metric such as an SINR, CQI, or any other quality or metric that is representative of a performance indicator, such as an RSRQ, a BLER, or a packet loss) for a geographic area. For example, in scenarios in which one or more hypothetical network configuration changes results in a serving cell power change (increase or decrease) by X dB, the mobile network operator 410 may use the serving cell power as is and adjust (such as increase or reduce) the signal strength by X dB (which may result in an SINR change of X dB in scenarios absent of interferer or noise changes). By way of example, one or more network configuration changes may result in a serving cell power reduced by 4 dB, which may correspond to a serving cell SINR reduction of 4 dB (assuming interfere and noise are without change).

In some implementations, the set of parameters 425 (such as the model 435, such as the device-level network performance matrix) may include a respective validity indication for each geographic area associated with the wireless communication network (which may be understood as a DMAP area validity indication or a DMAP tile validity indication). In such implementations, the server device 405 may indicate a set of validity indications to provide transparency as to which geographic areas are covered with device measurements or network information (such that, for example, an average RSRP value of serving and interferer cells is found for such geographic areas) and which geographic areas are not covered with (at least a threshold quantity of) device measurements or network information (to indicate that some metrics for such geographic areas may be inaccurate or not available). In some implementations, a matrix validity threshold definition may represent sufficient DMAP data existence for a geographic area to allow for decisions to be made using an evaluation of that geographic area. Additionally, or alternatively, a matrix validity threshold definition may represent sufficient data existence from one or more of various sources, such as from additional data sources associated with traces provided by an infrastructure network or entity, a propagation model based calculated geographic area RSRP, or an interpolation or extrapolation of data points concluded by a machine learning (ML) model. In other words, and more generally, any type of data source may be associated with a matrix validity threshold to represent or otherwise indicate a scenario in which data from that type of data source is eligible to conclude (such as finalize) a network planning decision. The server device may use a single matrix validity threshold (common to all data source types), two matrix validity thresholds, or any other quantity of matrix validity thresholds (such as a respective matrix validity threshold for each data source type). That is, for any of such possible data sources associated with the set of parameters 425, there may be a threshold for each data source, a threshold for some data sources, a threshold for all data sources, or any combination of one or more thresholds for all or a subset of the data sources.

By way of example, the set of parameters 425 may provide a first validity indication for a first geographic area, a second validity indication for a second geographic area, and so on. In some aspects, a validity indication for a geographic area may indicate whether the geographic area is valid for performance of the evaluation 430. For example, the validity indication for the geographic area may indicate whether that geographic area is valid for the evaluation 430 of the wireless communication network associated with one or more network configuration changes, invalid for the evaluation 430 of the wireless communication network associated with the one or more network configuration changes, or absent of data (such that, for example, this geographic area is absent of device or network data). A geographic area that is invalid for the evaluation 430 of the wireless communication network may be associated with a quantity of RSRP samples that is less than a threshold quantity, which may indicate that the quantity of RSRP samples may not be representative of a correct RSRP (at least with a threshold confidence level). Performance of the evaluation 430 may be in accordance with the validity indications. In this way, the set of parameters 425 may be a mature source of data (including trace information) to map use volume per geographic area.

FIG. 5 shows an example matrix composition 500 that supports a device-level network performance matrix 505. The device-level network performance matrix 505 may be an example of or may inform the model 435, as illustrated by and described with reference to FIG. 4. For example, the set of parameters 425 output from the server device 405 to the mobile network operator 410, as also illustrated by and described with reference to FIG. 4, may be indicative of or otherwise associated with the device-level network performance matrix 505. In other words, the set of parameters 425 may be the device-level network performance matrix 505 or may indicate the device-level network performance matrix 505. The device-level network performance matrix 505 may be equivalently referred to herein as a device-level performance matrix or a network performance matrix. In accordance with the matrix composition 500, the device-level network performance matrix 505 may include a user volume matrix 510, an interferer matrix 520, and an RSRP matrix 530.

The user volume matrix 510 may indicate a respective quantity of devices 515 (such as UEs 115) within each geographic area associated with a wireless communication network (such as for each geographic area 305 associated with the wireless communication network 300, as illustrated by and described with reference to FIG. 3). For example, the user volume matrix 510 may indicate a first quantity of devices within a first geographic area and a second quantity of devices within a second geographic area. In some implementations, a quantity of devices within a geographic area may be dynamic (such as variable) over time, such as in accordance with a mobility of devices within the wireless communication network. In such implementations, the user volume matrix 510 may indicate a different quantity of devices for a same geographic area at different times within a periodic cycle associated with the wireless communication network. In some implementations, the user volume matrix 510 may include a variable component and a static component. In other words, there may be self-variability of a quantity of devices per tile. A server device may obtain information indicative of the user volume matrix 510 via the device location information 420, as illustrated by and described with reference to FIG. 4. The server device may obtain the information indicative of the user volume matrix 510 from a service or platform (such as a DMAP), traces (such as traces provided by an infrastructure network or entity), one or more crowd devices or tools, one or more probe devices, or any combination thereof.

The server device may obtain the information indicative of the user volume matrix 510 at one or more of various data acquisition rates. Such one or more data acquisition rates may be associated with a quantity of DMAP capable devices within the wireless communication network. Additionally, or alternatively, such one or more data acquisition rates may be associated with a set of factors including a quantity of available compute resources at the server device or an available storage associated with the server device, among other examples. For example, the server device may acquire information indicative of the user volume matrix 510 with repetition, such as for each Monday at a clock time of 14:00 excluding holidays or at the beginning of a school year, among other examples. By way of further example, the server device may acquire information indicative of the user volume matrix 510 on an hourly basis or on a finer granularity than hourly (depending on compute resources or storage space, among other examples). In some implementations, the server device may collect device location information approximately once every 4 hours. To calculate a quantity of devices within each geographic area, the server device may set (such as configure, such as via wireless or wired signaling) a DMAP time interval to a few hours (such as approximately 4 hours, approximately 8 hours, or approximately 12 hours, among other examples) or to any other granularity (such as approximately 24 hours or approximately one week, among other examples) for which the server device (or the DMAP) may sum all devices within a given geographic area. The server device (or the DMAP) may aggregate the DMAP time interval over a past few months (such as over a past approximately 1, 2, 3, or 4 months, among other examples) to determine the respective quantity of devices 515 within each geographic area. The server device may perform such an aggregation of the DMAP time interval in accordance with an initial quantity of devices (such as DMAP capable devices) being relatively small. Additionally, or alternatively, and in scenarios in which there is a relatively small quantity of devices (such as DMAP capable devices), the server device may change a size of the geographic areas. For example, the server device may aggregate a quantity X of tiles such that a size of a geographic changes from Y to X*Y. By way of example, in scenarios in which each geographic area is 6 meters by 6 meters (initially or be default) and in which the server device aggregates 10 geographic areas together, a geographic area size may become 60 meters by 60 meters.

A data validity of the user volume matrix 510 (such as in accordance with a network configuration change having been performed) may be associated with an assumption that the quantity of users within each geographic area is constant (such as approximately or roughly constant) in accordance with obtaining a threshold amount (such as a critical mass) of information or obtaining location information associated with a threshold quantity of devices. Such an assumption that the quantity of users within each geographic area is constant may be associated with an assumption of an equal quantity of devices leaving and entering a geographic area (or leaving and entering the larger wireless communication network).

The interferer matrix 520 (a geographic area-based and device-level matrix) may indicate a respective set of interference metrics 525 for each geographic area associated with the wireless communication network. For example, the interferer matrix 520 may indicate a first set of interference metrics for a first geographic area and a second set of interference metrics for a second geographic area. In some implementations, a set of interference metrics may be associated with a set of interference sources for a given geographic area, may be load dependent, and may be dynamic over time, such as in accordance with variable loads (such as traffic loads or any other user volume representative indicator) at different interference sources over time. For example, the set of interference metrics may be dynamic over time in accordance with variable PRB utilization in downlink or uplink, variable traffic volume in downlink or uplink, a variable quantity of scheduled users, a variable quantity of RRC connected users, or any combination thereof. In such examples, the interferer matrix 520 may indicate different sets of interference metrics for a same geographic area at different times within a periodic cycle associated with the wireless communication network. The server device may obtain information indicative of the interferer matrix 520 via the network information 415, as illustrated by and described with reference to FIG. 4. The server device may obtain the information indicative of the interferer matrix 520 from the network or traces (such as traces provided by an infrastructure network or entity). The server device may obtain the information indicative of the interferer matrix 520 via indications that represent the cell load every day, every hour, every 15 minutes, or every 1 minute, among other example granularities at which the server device may obtain the information indicative of the interferer matrix 520.

The interferer matrix 520 may be associated with a respective load at each of one or more interferers for a given geographic area, with an interferer's load being dynamic over time (such as throughout a day) and informing (such as setting, influencing, or impacting) an SINR or CQI value (or any other quality or metric that is representative of a performance indicator, such as an RSRQ, a BLER, or a packet loss) for the given geographic area. The server device may obtain information indicative of the interferer matrix 520 at a data acquisition rate, such as approximately hourly (on an hourly basis). The interferer matrix 520 may indicate a traffic power (such as a traffic load) for each interference source of a respective set of interference sources for a given geographic area. The server device may calculate the traffic power for each interference source of a respective set of interference sources for a given geographic area in accordance with determining, for each interference source, whether that interference source provides a full interference contribution or a partial interference contribution, as described in more detail herein, including with reference to FIG. 4. For example, the server device may generate or update the interferer matrix 520 in accordance with determining, for each interference source, whether that interference source provides a full interference contribution or a partial interference contribution for a given geographic area. Additionally, or alternatively, the server device may combine information from the interferer matrix 520 with information indicative of which interference source(s) provide(s) a full interference contribution and which interference source(s) provide(s) a partial interference contribution for a given geographic area to generate a set of parameters, such as the set of parameters 425 as illustrated by and described with reference to FIG. 4.

In some scenarios, such as in scenarios in which a relatively small portion of devices within a geographic area or the wireless communication network are DMAP capable devices (DMAP supporting devices), the server device may complete the device-level network performance matrix 505 (or one or more components of the device-level network performance matrix 505, such as the RSRP matrix 530) with information obtained from a ray trace or any other propagation model (such as a propagation model based calculated geographic area RSRP), or any combination thereof. For example, the server device may complete or supplement the RSRP matrix 530 with one or more extrapolations or interpolations performed with an ML engine for RSRP values. By way of further example, the server device may complete or supplement the RSRP matrix 530 with one or more values calculated, predicted, estimated, or otherwise determined from a ray trace. For example, to obtain an accurate representation of the wireless communication network and to capture most areas in which devices operate, the server device may use trace data from a mobile network operator to capture (determine, identify, select, or otherwise calculate) a device portion per geographic area and may use the propagation model or the ray trace to determine (such as calculate, estimate, or predict) RSRPs of serving and interferer cells for geographic areas for which DMAP data is absent. In this way, the server device may complete the device-level network performance matrix 505 (or one or more components of the device-level network performance matrix 505, such as the RSRP matrix 530) using a hybrid network model built by DMAP and an accurate propagation model or ray trace source. For example, the server device may generate the device-level network performance matrix 505 by using any one or more types of data sources for the user volume matrix 510, the interferer matrix 520, or the RSRP matrix 530. In other words, and more generally, the server device may use a first set of one or more data sources for the user volume matrix 510, a second set of one or more data sources for the interferer matrix 520, and a third set of one or more data sources for the RSRP matrix 530. The first, second, and third sets of data sources may be the same, partially the same (such as partially overlapping), or different. Data sources may include a DMAP, traces, probes, crowd tools, the network, or prediction models, among other examples.

The RSRP matrix 530 (a geographic area-based and device-level matrix) may indicate a respective set of RSRP metrics 535 for each geographic area associated with the wireless communication network. For example, the RSRP matrix 530 may indicate a first set of RSRP metrics for a first geographic area and a second set of RSRP metrics for a second geographic area. A set of RSRP metrics for a geographic area may be associated with both a serving cell and a set of interference sources for the geographic area. For example, the set of RSRP metrics may include a first RSRP metric associated with a serving cell and one or more additional RSRP metrics associated with one or more interferer cells. The server device may obtain information indicative of the RSRP matrix 530 via the network information 415, as illustrated by and described with reference to FIG. 4. For example, the server device may obtain information indicative of the RSRP matrix 530 from a service or platform (such as a DMAP), from traces (such as traces provided by an infrastructure network or entity), from a prediction model (such as a propagation model based calculated geographic area RSRP), from one or more crowd devices or tools, from one or more probe devices, or any combination thereof. In some implementations, the server device may receive information of the RSRP matrix 530 directly from the DMAP.

In some implementations, the RSRP matrix 530 may be constant or approximately constant (in accordance with a reference signal transmit power being constant at a network entity 105, such as in accordance with a static RSRP cell power). For example, the server device may assume that the RSRP matrix 530 is constant. In such examples, a granularity associated with the RSRP matrix 530 may be a single value throughout a periodic cycle (such as throughout a day) associated with the wireless communication network. In other words, the RSRP of a serving cell or interferers for a given geographic area throughout one or more hours or one or more days may be assumed constant in accordance with assuming no changes (such as no transmit power changes, no antenna configuration changes, or any other change that might impact RSRP). Additionally, or alternatively, the server device may update the RSRP matrix 530 over time to account for dynamic environmental factors, such as moving objects, weather, temperature, or foliage, among other examples

A data validity of the RSRP matrix 530 (such as in accordance with a configuration change having been performed) may be associated with a threshold quantity of samples to obtain an accurate understanding of one or more RSRP values, such as an RSRP convergence. For example, the server device may classify the RSRP matrix 530 as including valid data (such as on a per geographic area basis) in accordance with RSRP measurements by devices within a same geographic area converging toward a same RSRP value. By way of further example, the server device may classify the RSRP matrix 530 as including invalid data (such as on a per geographic area basis) in accordance with RSRP measurements by devices within a same geographic area failing to converge toward a same RSRP value.

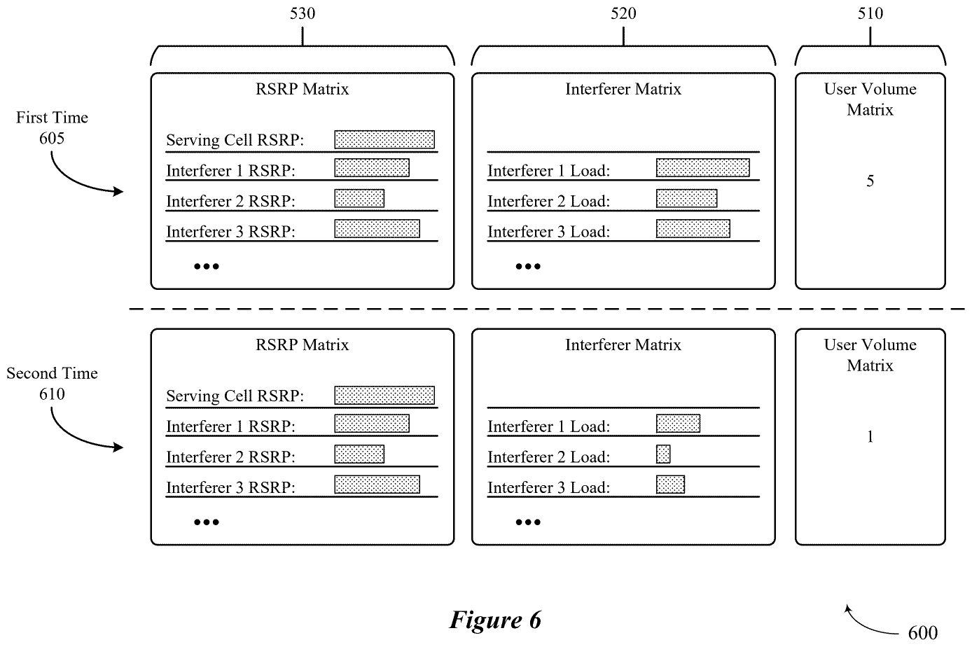

FIG. 6 shows an example geographic area-level view 600 of the device-level network performance matrix 505 in accordance with the example matrix composition 500. For example, the geographic area-level view 600 of the device-level network performance matrix 505 illustrates example matrix values associated with each of the user volume matrix 510, the interferer matrix 520, and the RSRP matrix 530 at a same geographic area over time, such as at a first time 605 and a second time 610.

In accordance with the geographic area-level view 600, the RSRP matrix 530 may indicate a same set of RSRP metrics for the geographic area at the first time 605 and the second time 610 (in accordance with the RSRP matrix 530 being constant or assumed as being constant). Further, the interferer matrix 520 may indicate a first set of interference metrics for the geographic area at the first time 605 and a second (different) set of interference metrics for the geographic area at the second time 610. Example interference metrics include a load (such as a traffic load, such as a downlink PRB or other communication resource utilization) for each interferer (such as for each interference source). Additionally, the user volume matrix 510 may indicate a first quantity of devices (such as 5) within the geographic area at the first time 605 and a second (different) quantity of devices (such as 1) within the geographic area at the second time 610. By way of example, the first time 605 may be associated with a clock time of 16:00 and the second time 610 may be associated with a clock time of 01:00. Additionally, or alternatively, the user volume matrix 510 may indicate a first traffic load or volume, a first PRB utilization, or any other metric associated with a first user intensity level within the geographic area at the first time 605 and may indicate a second (different) traffic load or volume, a second PRB utilization, or any other metric associated with a second user intensity level within the geographic area at the second time 610.

In accordance with the device-level network performance matrix 505 being associated with one or more components that are at least partially variable in space and time and each indicative of multiple values or metrics for a given space and time, the device-level network performance matrix 505 may be understood as a 3D matrix associated with a wireless communication network (such as the wireless communication network 100 or the wireless communication network 300). In other words, the device-level network performance matrix 505 may inform, be associated with, or be used equivalently as a model of the wireless communication network, such as the model 435 as illustrated by and described with reference to FIG. 4. In accordance with such aspects, the model 435 may be an RF network model including a comprehensive interference matrix (such as the interferer matrix 520 or the RSRP matrix 530, or both, of the device-level network performance matrix 505) of serving cells and interfering cells (interferer cells) for each geographic area associated with the wireless communication network. The device-level network performance matrix 505 may be composed in accordance with measured (such as actual or real-world) data or predicted data, or any combination thereof, from one or more of various information sources, including use of traces to recognize where devices operate and complementing DMAP geographic areas with ray trace geographic areas to cover a target percentage (such as 100%) of the (trace) geographic areas. Further, considering the 3D space associated with the wireless communication network, the device-level network performance matrix 505 may be composed in accordance with a data source that indicates where devices (such as UEs 115) operate, which may supplement (such as complete) DMAP data with other data (such as ray trace data). The supplement (or completion) may be made on a 3D axis including height (such as of indoor locations). A server device may compose the device-level network performance matrix 505 in accordance with knowledge of where the devices operate via traces or via any one or more of various possible data sources.

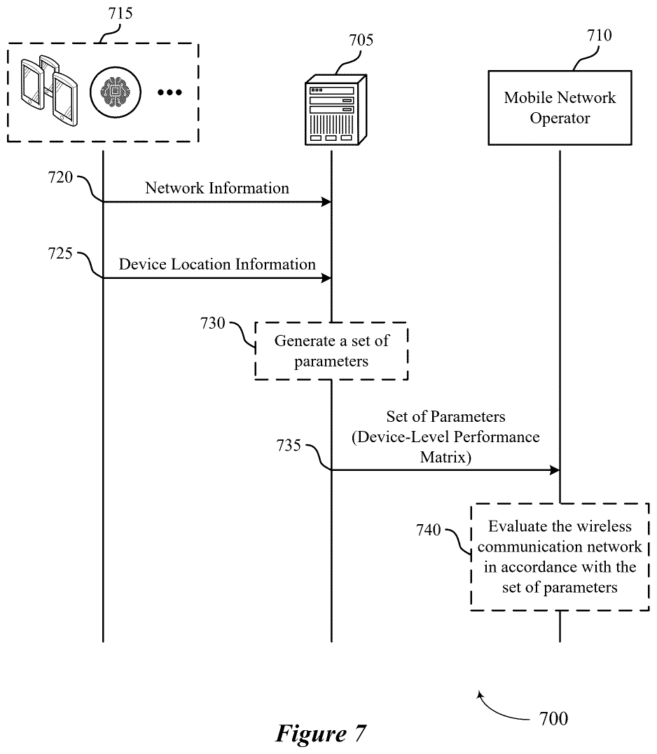

FIG. 7 shows an example process flow 700 that supports a device-level network performance matrix. The process flow 700 may implement or be implemented to realize one or more aspects of the wireless communication network 100, the antenna configuration update 200, the wireless communication network 300, the signaling diagram 400, the matrix composition 500, or the geographic area-level view 600. For example, the process flow 700 illustrates communication between a server device 705, a mobile network operator 710, and one or more information sources 715. The server device 705 may be an example of the server device 405 as illustrated by and described with reference to FIG. 4. The mobile network operator 710 may be an example of the mobile network operator 410 as illustrated by and described with reference to FIG. 4. The one or more information sources 715 may include one or more devices (such as one or more UEs 115, such as DMAP devices), one or more propagation models (such as one or more propagation model based calculated geographic area RSRPs), traces (such as traces provided by an infrastructure network or entity), one or more crowd devices or tools, one or more probe devices, one or more network devices, or any combination thereof, among other examples.

In the following description of the process flow 700, some operations may be omitted from the process flow 700, and some other operations may be added to the process flow 700. Further, although some operations or messaging (such as via wired or wireless communication, in accordance with one or more of various communication protocols) may be shown to occur at different times for discussion purposes, these operations may occur at the same time.

At 720, the server device 705 may obtain network information associated with a set of devices (such as a set of UEs 115) within a wireless communication network. The network information may be an example of the network information 415 as illustrated by and described with reference to FIG. 4. The network information may indicate a respective set of RSRP metrics and a respective set of interference metrics for each geographic area of multiple geographic areas associated with the wireless communication network. For example, the network information may indicate a set of RSRP metrics and a set of interference metrics on a per geographic tile basis. In some implementations, a first information source may indicate the respective set of RSRP metrics for each geographic area and a second information source may indicate the respective set of interference metrics for each geographic area. In some implementations, an RSRP matrix, such as the RSRP matrix 530 of FIGS. 5 and 6, may indicate the respective set of RSRP metrics for each geographic area. In some implementations, an interferer matrix, such as the interferer matrix 520 of FIGS. 5 and 6, may indicate the respective set of interference metrics for each geographic area. The server device 705 may obtain the network information via wired or wireless signaling, or via a combination of wired and wireless signaling.

At 725, the server device 705 may obtain device location information associated with the set of devices within the wireless communication network. The device location information may be an example of the device location information 420 as illustrated by and described with reference to FIG. 4. The device location information may indicate a respective quantity of devices within each geographic area associated with the wireless communication network. In some implementations, a user volume matrix, such as the user volume matrix 510 of FIGS. 5 and 6, may indicate the respective quantity of devices for each geographic area. The server device 705 may obtain the device location information via wired or wireless (such as Wi-Fi or cellular) signaling, or via a combination of wired and wireless signaling.

At 730, the server device 705 may generate a set of parameters (such as a device-level network performance matrix) in accordance with the network information and the device location information. The set of parameters may be an example of the set of parameters 425 as illustrated by and described with reference to FIG. 4. In some implementations, the set of parameters may be associated with a model of the wireless communication network, such as the model 435 of FIG. 4. The server device 705 may generate the set of parameters to provide the model to the mobile network operator 710. For example, the set of parameters may be or may indicate the model 435 of FIG. 4 or the device-level network performance matrix 505 of FIG. 5, or both. Additionally, or alternatively, the server device 705 may generate the set of parameters as part of running the model (such that the set of parameters may be outputs of the model, such as network planning decisions or parameters usable to make network planning decisions).

At 735, the server device 705 may output the set of parameters to the mobile network operator 710. The server device 705 may output the set of parameters to the mobile network operator 710 via a single message or multiple messages. The server device 705 may output the set of parameters to the mobile network operator 710 via wired or wireless signaling, or via a combination of wired and wireless signaling. In some implementations, the server device 705 may output the set of parameters to the mobile network operator 710 via an application program interface (API).

At 740, the mobile network operator 710 may evaluate the wireless communication network in accordance with the set of parameters. For example, the mobile network operator 710 may perform an evaluation, such as the evaluation 430 as illustrated by and described with reference to FIG. 4, of the wireless communication network in accordance with the set of parameters. In some implementations, the evaluation may include calculating a performance indicator metric (such as an SINR, a CQI, or any other quality or metric representative of a performance indicator, such as an RSRQ, a BLER, or a packet loss (and, from the performance indicator metric, a throughput and a user experience score, or any other performance indicator associated with network performance) for each geographic area of the multiple geographic areas associated with the wireless communication network. For example, the evaluation may include an SINR, CQI, or throughput calculation (such as an SINR, CQI, or throughput assessment, or an assessment of any other quality or metric representative of a performance indicator, such as of an RSRQ, a BLER, or a packet loss) for each geographic area after a predicted, simulated, or actual (cell or network) configuration change.

By way of further example, the evaluation may include calculating a change in dB to a geographic area's point (assuming a cell antenna pattern) for each cell configuration change (such as calculating a new RSRP post change), calculating a new SINR or CQI (or any other quality or metric representative of a performance indicator metric, such as an RSRQ, a BLER, or a packet loss) as a result of the cell configuration change at the antenna pattern angle (in accordance with a geometry calculation) of the geographic area's direction (which may include selectively classifying interference sources as full or partial interference contributors relative to their respective RSRP metrics), calculating the impact of the cell configuration change for a set of (such as all) geographic areas in which the changed cell appears as a serving cell or an interfering cell, determining a quantity of devices per geographic area, and calculating an overall user impact SINR, CQI, or any other quality or metric representative of a performance indicator metric, such as RSRQ, BLER, or packet loss) (which may be calculated for a busy hour or a 24 hour cycle, among other examples). The evaluation may include determining an overall network throughput (such as an overall impacted users' throughput) in accordance with the overall user impact SINR or CQI (or any other quality or metric representative of a performance indicator metric). In some implementations, the server device 705 or the mobile network operator 710, or both, may train an artificial intelligence (AI) model to determine a network configuration (such as a network configuration that achieves a target or threshold performance indicator metric such as a target or threshold SINR, a target or threshold CQI, a target or threshold throughput, or any other quality or metric representative of a performance indicator metric, such as RSRQ, BLER, or packet loss) in accordance with the network information, the device location information, the set of parameters, or any combination thereof.

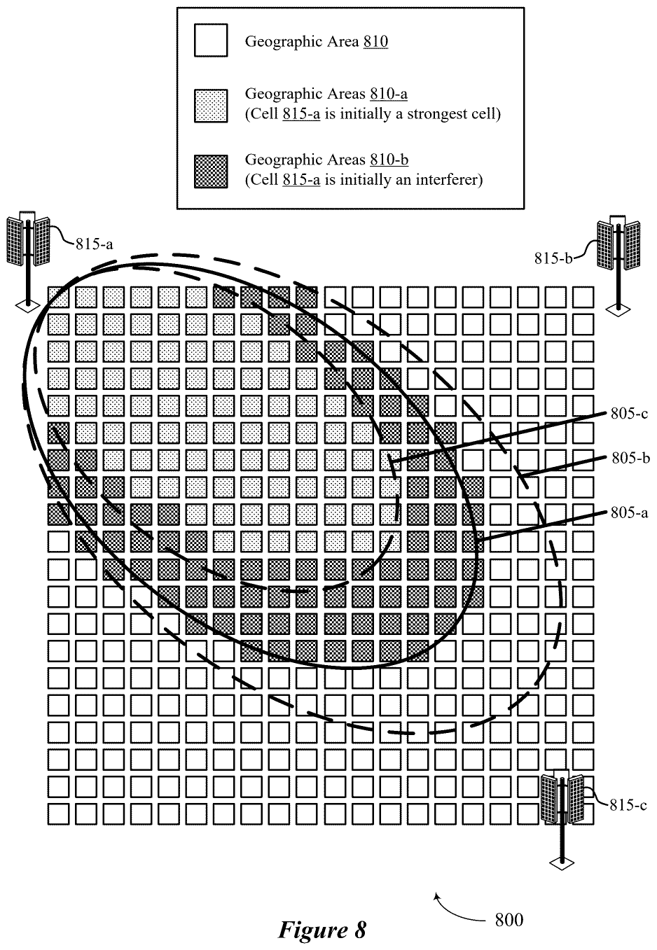

FIG. 8 shows an example network configuration change 800 that supports (or otherwise uses or leverages) a device-level network performance matrix. The network configuration change 800 illustrates various example cell coverage areas of a cell 815-a including a coverage area 805-a before the network configuration change 800, a coverage area 805-b after the network configuration change 800 in scenarios in which the cell coverage area increases (such as is extended), and a coverage area 805-c after the network configuration change 800 in scenarios in which the cell coverage area decreases (such as is reduced). In accordance with some example implementations, a network operator, such as the mobile network operator 410 of FIG. 4 or the mobile network operator 710 of FIG. 7, may simulate (such as calculate, predict, detect, or otherwise determine) an impact of the network configuration change 800 (before deploying or orchestrating the network configuration change 800 in an actual, real-world wireless communication network) using a device-level network performance matrix, such as the model 435 of FIG. 4 or the device-level network performance matrix 505 of FIG. 5.

The wireless communication network may include a set of cells including the cell 815-a, a cell 815-b, and a cell 815-c. In some aspects, each cell may be associated with a respective network entity 105, such as a network entity 105 as illustrated by and described with reference to FIGS. 1-4. The cell 815-a may be an example of a serving cell for one or more devices (such as one or more UEs 115) and, from the perspective of the one or more devices, the cell 815-b and the cell 815-c may be examples of interferer cells. For example, from the perspective of the one or more devices for which the cell 815-a is a serving cell, the cell 815-b may be an example of a first interferer cell, and the cell 815-c may be an example of a second interferer cell.

The network configuration change 800 may be associated with (such as applied to or effective in) a wireless communication network that is associated with (such as includes) geographic areas 810, which may be examples of the geographic areas 305 of FIG. 3. The geographic areas 810 may include geographic areas 810-a within which the cell 815-a is initially (such as prior to the network configuration change 800) a serving cell (such as a strongest cell) and may include geographic areas 810-b within which the cell 815-a is initially (such as prior to the network configuration change 800) an interferer cell (from the perspective of devices that use another cell as a serving cell). The cell 815-b or the cell 815-c may be a serving cell for the geographic areas 810-b within which the cell 815-a is an interferer cell. The geographic areas 810 that are impacted by a change at the cell 815-a may be associated with the coverage area of the cell 815-a. For example, a coverage area of the cell 815-a may include (such as encompass) the set of geographic areas 810 that are geographic areas 810-a and geographic areas 810-b.

For example, in implementations in which the network configuration change 800 extends the coverage of the cell 815-a from the coverage area 805-a to the coverage area 805-b, the cell 815-a may be an interferer to a greater quantity of geographic areas 810 (such that the quantity of geographic areas 810-b may increase). Additionally, or alternatively, the geographic areas 810 within which the cell 815-a is an interferer cell may shift to be farther away from the cell 815-a. Additionally, or alternatively, an interference level of the cell 815-a may increase. Additionally, or alternatively, such an extension in coverage by the cell 815-a may increase a serving cell RSRP for devices within geographic areas 810-a that use the cell 815-a as a serving cell. Additionally, or alternatively, such an extension in coverage by the cell 815-a may increase a quantity of the geographic areas within which the cell 815-a is a strongest (such as best) serving cell. Executing an extended cell coverage at the cell 815-a may include (such as be the result of) increasing a transmit power of the cell 815-a or up-tilting an antenna of the cell 815-a, or both.

In such implementations in which the network configuration change 800 extends the coverage of the cell 815-a from the coverage area 805-a to the coverage area 805-b, different regions (such as categories) of geographic areas 810 may be associated with different behaviors because of the network configuration change 800. For example, there may be four regions each associated with a respective behavior because of the network configuration change 800. Each of the four regions may be associated with a different distance from the cell 815-a. For example, a first region may be closest to the cell 815-a, a second region may be second closest to the cell 815-a, a third region may be third closest to the cell 815-a, and a fourth region may be farthest from the cell 815-a. The first region may be defined as one or more geographic areas 810 within which the cell 815-a is a best serving cell prior to the network configuration change 800 and within which the cell 815-a remains the best serving cell after the network configuration change 800 (with a higher SINR). The second region may be defined as one or more geographic areas 810 within which the cell 815-a is an interferer cell prior to the network configuration change 800 and within which the cell 815-a becomes a best serving cell after the network configuration change 800. In accordance with the cell 815-a becoming a serving cell for more geographic areas 810 after the network configuration change 800, a traffic or volume associated with the cell 815-a may be re-calculated (higher). The third region may be defined as one or more geographic areas 810 within which the cell 815-a is an interferer cell prior to the network configuration change 800 and within which the cell 815-a remains as an interferer cell after the network configuration change 800 with a greater impact over the cell 815-b and the cell 815-c. The fourth region may be defined as one or more geographic areas 810 within which the cell 815-a is not measured (such as not detected) prior to the network configuration change 800 and within which the cell 815-a becomes an interferer cell for the cell 815-b and the cell 815-c after the network configuration change 800.

By way of further example, in implementations in which the network configuration change 800 reduces the coverage of the cell 815-a from the coverage area 805-a to the coverage area 805-c, the cell 815-a may be an interferer to a smaller quantity of geographic areas 810 (such that the quantity of the geographic areas 810-b may decrease). Additionally, or alternatively, an interference level of the cell 815-a may decrease. Additionally, or alternatively, such a reduction in coverage by the cell 815-a may decrease a serving cell RSRP for devices within geographic areas 810-a that use the cell 815-a as a serving cell. Additionally, or alternatively, such a reduction in coverage by the cell 815-a may decrease a quantity of the geographic areas within which the cell 815-a is a strongest (such as best) serving cell. Executing a reduced cell coverage at the cell 815-a may include (such as be the result of) decreasing a transmit power of the cell 815-a or down-tilting an antenna of the cell 815-a, or both.

In such implementations in which the network configuration change 800 reduces the coverage of the cell 815-a from the coverage area 805-a to the coverage area 805-c, different regions (such as categories) of geographic areas 810 may be associated with different behaviors because of the network configuration change 800. For example, there may be four regions each associated with a respective behavior because of the network configuration change 800. Each of the four regions may be associated with a different distance from the cell 815-a. For example, a first region may be closest to the cell 815-a, a second region may be second closest to the cell 815-a, a third region may be third closest to the cell 815-a, and a fourth region may be farthest from the cell 815-a. The first region may be defined as one or more geographic areas 810 within which the cell 815-a is a best serving cell prior to the network configuration change 800 and within which the cell 815-a remains the best serving cell after the network configuration change 800. The second region may be defined as one or more geographic areas 810 within which the cell 815-a is a best serving cell prior to the network configuration change 800 and within which the cell 815-a becomes an interferer cell after the network configuration change 800. In accordance with the cell 815-a becoming a serving cell for fewer geographic areas 810 after the network configuration change 800, a traffic or volume associated with the cell 815-a may be re-calculated (lower). In some implementations, the traffic or volume may be shifted from the cell 815-a to the cell 815-b or the cell 815-c, or both, and a device (such as a network operator) may calculate the traffic or volume shift in accordance with the traffic volume per geographic area. The third region may be defined as one or more geographic areas 810 within which the cell 815-a is an interferer cell to the cell 815-b and the cell 815-c prior to the network configuration change 800 and within which the cell 815-a remains as an interferer cell after the network configuration change 800 with a smaller impact over the cell 815-b and the cell 815-c. The fourth region may be defined as one or more geographic areas 810 within which the cell 815-a is an interferer cell to the cell 815-b and the cell 815-c prior to the network configuration change 800 and within which the cell 815-a does not have an impact (is not measured or detected) after the network configuration change 800.

Using the device-level network performance matrix, the network operator may calculate an impact, across one or multiple geographic areas 810 (individually or in aggregation), in accordance with any one or more of a quantity of the geographic areas 810-a (the geographic areas within which the cell 815-a is a strongest serving cell), increases or decreases in the quantity of the geographic areas 810-b, increases or decreases in the interferer cell RSRP of the cell 815-a, or increases or decreases in the serving cell RSRP of the cell 815-aan RSRP level of a serving cell and of one or more interfering cells, and noise. The network operator may further account for a user intensity level within each geographic area 810 in accordance with the device-level network performance matrix, among other aspects disclosed herein. The network operator may calculate the impact as an SINR impact or a CQI impact, or both, (or any other quality or metric that is representative of a performance indicator, such as a counter KPI, an RSRQ, a BLER, or a packet loss) across the one or multiple geographic areas 810 (individually or in aggregation). In some implementations, the SINR impact or the CQI impact, or both, (or, more generally, the performance indicator metric impact) may be translated to an overall throughput impact or any other performance indicator, such as a PM or a KPI that represents one or more cells or a network spectral efficiency (such as in accordance with accounting for the user intensity level within each geographic area 810).

In some implementations, the network operator may use (such as leverage or utilize) the network configuration change 800 to improve network coverage, service quality, or both at a network weak spot according to device-level (such as UE-level) data. For example, the network operator may update antenna configurations for one or more network entities 105 of the wireless communication network to resolve the network weak spot in accordance with simulating the network configuration change 800 using the device-level network performance matrix. A device (such as a DMAP capable device) may identify (such as select, determine, calculate, detect, or otherwise ascertain) a network weak spot in accordance with data associated with devices (such as UEs 115) operating within the wireless communication network. The network operator may select (such as determine, identify, calculate, predict, detect, or otherwise ascertain) the network configuration change 800 (such as a change or update to an antenna configuration parameter of a network entity 105) that mitigates, or otherwise resolves, the network weak spot. In some implementations, the network operator may use the device-level network performance matrix to select the network configuration change 800. An update to the antenna configuration parameter may be an example of an update to an angle of transmission (such as an up-tilt or down-tilt of an antenna panel), a transmit power, an antenna profile, an antenna azimuth, an antenna type, or any combination thereof, among other examples of network parameters that the network operator may (dynamically) update. In some implementations, the network operator may select multiple updates to multiple antenna configuration parameters for one or more network entities 105 of the wireless communication network.

Some aspects and techniques as described herein may be implemented, at least in part, using an AI program, such as a program that includes a machine learning (ML) or artificial neural network (ANN) model. An example ML model may include mathematical representations or define computing capabilities for making inferences from input data according to patterns or relationships identified in the input data. As used herein, the term “inferences” can include one or more of decisions, predictions, determinations, or values, which may represent outputs of the ML model. The computing capabilities may be defined in terms of one or more parameters of the ML model, such as weights and biases. Weights may indicate relationships between specific input data and specific outputs of the ML model, and biases are offsets which may indicate a starting point for outputs of the ML model. An example ML model operating on input data may start at an initial output according to the biases and update its output according to a combination of the input data and the weights. In some implementations, a network operator may use a model (such as an ML or ANN model) to find a suitable network configuration to boost user and network throughput. In some implementations, an application server may provide the model to the network operator. In some other implementations, the network operator may obtain the model from another device, entity, or functionality. The model, which may be understood as an ML optimizer, may be an example of a reinforcement learning model that the network operator may use to find (such as determine or select) a suitable network configuration to boost user and network throughput.

In some aspects, an ML model (such as the device-level network performance matrix described herein, such as the device-level network performance matrix 505 of FIG. 5) may be configured to provide computing capabilities for wireless communications. Such an ML model may be configured with weights and biases to improve network coverage, for example, by adjusting (or requesting adjustments to) antenna configuration parameters at one or more network entities 105 to mitigate, or otherwise remove, network weak spots or otherwise increase a throughput for one or more users (such as an overall network throughput). The ML model may support location-based automation in accordance with cell telemetry. During operation of a device, the ML model may receive input data such as UE data, DMAP data, network data, or some combination thereof associated with geographic information. The ML model may make inferences such as recommended or suggested updates to one or more antenna configuration parameters for one or more network entities 105 in accordance with the weights and biases.

ML models may be deployed in one or more devices (such as network entities 105, UEs 115, server devices, edge devices, or devices supporting a service or platform, such as a DMAP) and may be configured to enhance various aspects of a wireless communications system. For example, an ML model may be trained to identify patterns or relationships in data corresponding to a network, a device, an air interface, or the like. Such an ML model may be the device-level network performance matrix or may be trained using the device-level network performance matrix. An ML model (such as the device-level network performance matrix) may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, antenna configurations, or any combination thereof.

ML models may be characterized in terms of types of learning that generate specific types of learned models that perform specific types of tasks. For example, different types of ML include supervised learning, unsupervised learning, semi-supervised learning, reinforcement learning, among other examples. ML models may be used to perform different tasks such as classification or regression, where classification refers to determining one or more discrete output values from a set of predefined output values, and regression refers to determining continuous values which are not bounded by predefined output values. For example, a classification ML model may produce an output which includes a selection (such as a determination, an identification, or a recommendation) of network entities affecting a network weak spot, such as one or more interferers, one or more natural serving cells, one or more interferer compensators, or any combination thereof. A regression ML model may produce an output which includes a selection (such as determination, calculation, recommendation) of one or more updates to antenna configuration parameters, such as one or more updates to antenna angles, transmit powers, antenna profiles, antenna azimuths, antenna port configurations, or any combination thereof. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), among other examples.

In some aspects of this disclosure, a service or platform may implement a reinforcement learning AI model that uses a greedy approach to optimize, or otherwise improve, antenna configurations (among other cell or network configurations) for a set of network entities 105 of a wireless network. The AI model may implement an AI optimizer engine or other component to select (such as determine, predict, estimate, or otherwise ascertain) one or more antenna configurations or one or more antenna configuration updates for one or more network entities 105 that satisfy, or otherwise meet, one or more conditions. In some implementations, the service or platform may configure the one or more conditions to adjust the AI optimization scheme. The one or more conditions may include improving signal metrics (such as SINR or CQI values, or any other quality or metric that is representative of a performance indicator, such as RSRQ, BLER, or packet loss) for a network weak spot to meet, or otherwise satisfy, a threshold signal metric (such as a threshold SINR or CQI, a threshold throughput, a threshold user experience score, a threshold RSRQ, a threshold BLER, or a threshold packet loss). For example, the threshold signal metric may be an example of a minimum allowed SINR or CQI value configured for an operator or service. Additionally, or alternatively, the one or more conditions may include not creating any new coverage gaps within the wireless communication network (such as indicated by RSRP or other signal measurements for an operator or service). Additionally, or alternatively, the one or more conditions may include not creating any new network weak spots within the wireless communication network (such as geographic areas with average signal metrics below the threshold signal metric, such as SINR or CQI values below an SINR or CQI threshold for an operator or service).

Additionally, or alternatively, the one or more conditions may include satisfying, or otherwise meeting, a threshold improvement rate for the wireless network. The threshold improvement rate may be associated with an overall SINR or CQI value (or any other quality or metric that is representative of a performance indicator, such as RSRQ, BLER, or packet loss) for a set of impacted geographic areas, an overall throughput for the set of impacted geographic areas, or both for any time period, such as a day, multiple days, a specific hour (such as the hour with the most user traffic), a quantity of minutes or seconds, or any combination thereof. In some implementations, a mobile network operator (MNO) may configure the threshold improvement rate for the wireless network. If the AI model selects (such as determines, identifies, calculates, or otherwise ascertains) updates to network parameters, such as antenna configuration parameters or other network parameters, that satisfy the one or more conditions, the service or platform hosting the AI model may send an indication of the updates to network parameters to the wireless network (such as to the MNO, to a core network, to one or more network entities 105) requesting that the wireless network perform the indicated updates. In some implementations, additional, or alternative, conditions may be configured for the AI optimization. In some implementations, the AI model may use, or indicate, RSRP metrics, SINR or CQI values, interference metrics, device quantity metrics, any other quality or metric that is representative of a performance indicator, or any combination thereof.

The description herein illustrates, by way of some examples, how one or more tasks or problems in wireless communications may benefit from the application of one or more ML models to improve network coverage, for example, by removing or mitigating network weak spots. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

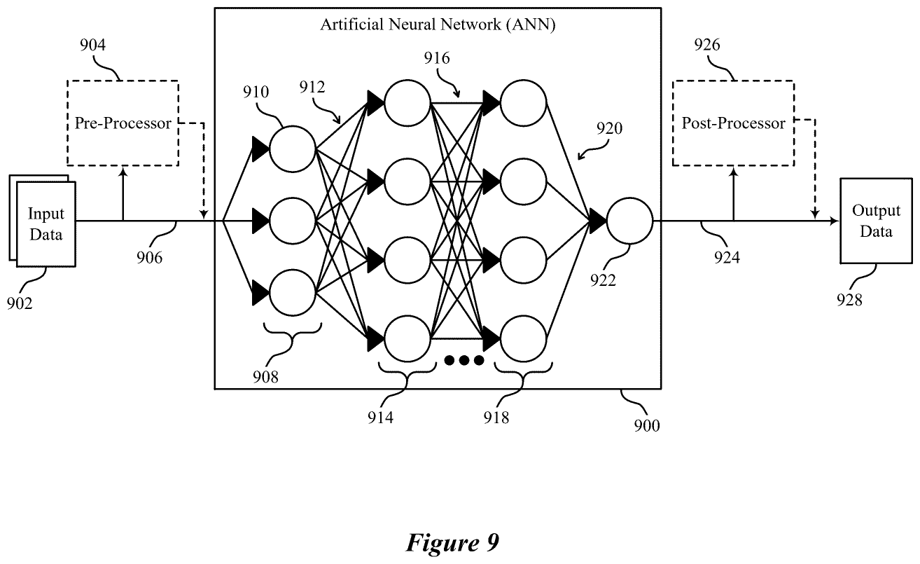

FIG. 9 shows an example block diagram of an example ML model represented by an ANN 900 that supports a device-level network performance matrix. The ANN 900 may receive input data 906 which may include one or more bits of data 902, pre-processed data output from a pre-processor 904, or some combination thereof. Here, data 902 may include training data, verification data, application-related data, or the like, according to, for example, the stage of deployment of the ANN 900. The pre-processor 904 may be included within the ANN 900 in some other implementations. The pre-processor 904 may, for example, process all or a portion of the data 902 which may result in some of the data 902 being changed, replaced, deleted, or otherwise modified. In some implementations, the pre-processor 904 may add additional data to the data 902. In some implementations, the pre-processor 904 may be an example of an ML model, such as another ANN. In some implementations, such as a service or platform (such as a DMAP), among other information sources, may collect the data 902 for training the ANN 900, running the ANN 900, or both. For example, the DMAP (or one or more other information sources) may collect and aggregate data 902 from multiple UEs 115 operating within a wireless network. The DMAP (or the one or more other information sources) may label the data, create datasets, identify features, or perform any other operations to support the ANN 900.

The ANN 900 may include at least one first layer 908 of artificial neurons 910 to process input data 906 and provide resulting first layer data via connections or “edges” such as edges 912 to at least a portion of at least one second layer 914. The second layer 914 may process data received via the edges 912 and may provide second layer output data via edges 916 to at least a portion of at least one third layer 918. The third layer 918 may process data received via the edges 916 and may provide third layer output data via edges 920 to at least a portion of a final layer 922 including one or more artificial neurons 910 to provide output data 924. In some implementations, all or part of the output data 924 may be further processed in some manner by a post-processor 926. The ANN 900 may provide output data 928 that is in accordance with the output data 924, post-processed data output from the post-processor 926, or some combination thereof.

The post-processor 926 may be included within the ANN 900 in some other implementations. The post-processor 926 may, for example, process all or a portion of the output data 924 which may result in the output data 928 being different, at least in part, to the output data 924, as result of data being changed, replaced, deleted, or otherwise modified. In some implementations, the post-processor 926 may be configured to add additional data to the output data 924. The second layer 914 and the third layer 918 may represent intermediate or hidden layers that may be arranged in a hierarchical or other like structure. Although not explicitly shown, there may be one or more further intermediate layers between the second layer 914 and the third layer 918. In some implementations, the post-processor 926 may be an ML model, such as another ANN.

The structure and training of artificial neurons 910 in the various layers may be tailored to specific rules or conditions of an application. Within a given layer such as the first layer 908, the second layer 914, or the third layer 918 of the ANN 900, some or all of the artificial neurons 910 may be configured to process information provided to the layer and output corresponding transformed information from the layer. For example, transformed information from a layer may represent a weighted sum of the input information associated with or otherwise in accordance with a non-linear activation function or other activation function used to “activate” artificial neurons of a next layer. Artificial neurons in such a layer may be activated by or be responsive to parameters such as the previously described weights and biases of the ANN 900. The weights and biases of the ANN 900 may be adjusted during a training process or during operation of the ANN 900. The weights of the various artificial neurons 910 may control a strength of connections between layers or artificial neurons 910, while the biases may control a direction of connections between the layers or artificial neurons 910. An activation function may select (such as determine or otherwise ascertain) whether an artificial neuron 910 transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 906. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the ANN 900, may be conducted using training data. Training data may include one or more datasets which the ANN 900 may use to identify patterns or relationships. Training data may represent various types of information, including written, visual, audio, environmental context, operational properties, or other data. During training, the parameters (such as the weights and biases) of the artificial neurons 910 may be changed, such as to minimize or otherwise reduce a loss function or a cost function. A training process may be repeated multiple times to fine-tune the ANN 900 with each iteration.

The ANN 900 or other ML models may be implemented in various types of processing circuits along with memory and applicable instructions therein. For example, general-purpose hardware circuits, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like also may be employed. In some implementations, the ML model may be implemented by an NPU or a TPU embedded in a system-on-a-chip (SoC) along with other components, such as one or more CPUs, GPUs, or the like. An SoC may include several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs also may receive the inferences and be configured to perform certain actions according to the inferences produced by the ML model. The actions performed by the one or more CPUs may include sending commands to other components of the SoC or components external to the SoC to perform certain actions. For example, the CPU may send commands to a transceiver in accordance with the outputs or inferences obtained from an ML model to cause the transceiver to operate on a wireless network in accordance with the ML model.

In some implementations, one or more devices or services may support processes relating to an ML model's usage, maintenance, activation, reporting, or the like. In some implementations, all or part of a dataset or model may be shared across multiple devices, to provide or otherwise augment or improve processing. In some implementations, signaling mechanisms may be utilized at various nodes of a wireless network to signal the capabilities for performing specific functions related to the ML model, support for specific ML models, capabilities for gathering, creating, transmitting training data, or other ML related capabilities. ML models in wireless communications systems may, for example, be employed to support decisions or improve performance relating to wireless resource allocation or selection, wireless channel condition estimation, interference mitigation, beam management, positioning accuracy, energy savings, modulation or coding schemes, network configuration changes, or any combination of these or other network parameters. In some implementations, model deployment may occur jointly or separately at various network levels, such as, a UE 115, a network entity 105 such as a base station, a disaggregated network entity 105 such as a CU, DU, or RU, a server device, an edge device, a device supporting a service or platform for data management and analytics, or any combination thereof.

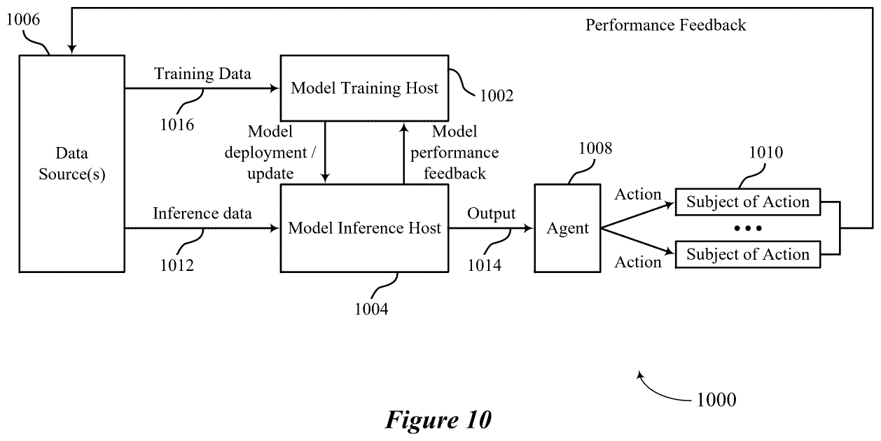

FIG. 10 shows an example block diagram of an example ML architecture 1000 that supports a device-level network performance matrix. As illustrated, the ML architecture 1000 may include multiple logical entities, such as a model training host 1002, a model inference host 1004, one or more data sources 1006, and an agent 1008. The model inference host 1004 is configured to run an ML model in accordance with inference data 1012 provided by the one or more data sources 1006. The model inference host 1004 may produce output 1014, which may include a prediction or inference, such as a discrete or continuous value in accordance with the inference data 1012, which may be provided as an input to the agent 1008.

The agent 1008 may represent an element or an entity of a wireless communications system including, for example, a RAN, a wireless local area network, a D2D communications system, or any other system. As an example, the agent 1008 may be a network entity 105, such as a network entity 105 described with reference to FIGS. 1-5. In some implementations, the network entity 105 may be a CU, a DU, or an RU. Additionally, or alternatively, the agent 1008 also may be a type of agent that depends on the type of tasks performed by the model inference host 1004, the type of inference data 1012 provided to the model inference host 1004, or the type of output 1014 produced by the model inference host 1004.

The agent 1008 may perform one or more actions associated with receiving the output 1014 from the model inference host 1004. For example, if the agent 1008 is, or represents, a device associated with a service or platform or a network entity 105, and the output from the model inference host 1004 is associated with a network weak spot, an antenna configuration update (or any other configuration change), or both, the agent 1008 may determine whether to change or modify an antenna configuration according to the output 1014. The agent 1008 may indicate the one or more actions performed to at least one subject of an action 1010. For example, if the agent 1008 determines to change or modify an antenna configuration for a network entity 105, the agent 1008 may send a signal requesting an update to an antenna configuration to the subject of the action 1010 (such as the network entity 105). In some implementations, the agent 1008 and the subject of the action 1010 may be the same entity.

Data can be collected from data sources 1006 and may be used as training data 1016 for training an ML model or as inference data 1012 for feeding an ML model inference operation. The data sources 1006 may collect data from various subject of the actions 1010 (such as network entities 105) or other entities (such as UEs 115 operating within a wireless network) and may provide the collected data to a model training host 1002 for ML model training. In some implementations, DMAP or another data management platform may collect the data from multiple UEs 115 to determine (or otherwise select) network weak spots according to user experiences of the UEs 115. In some implementations, if the output 1014 provided to the agent 1008 is inaccurate (or the accuracy is below an accuracy threshold), the model training host 1002 may provide feedback to the model inference host 1004 to modify or retrain the ML model used by the model inference host 1004, such as via an ML model deployment update.

The model training host 1002 may be deployed at the same or a different entity than that in which the model inference host 1004 is deployed. For example, to offload model training processing, which can impact the performance of the model inference host 1004, the model training host 1002 may be deployed at a model server or other processing device or system.

In some implementations, an ML model is deployed at or on a device supporting a service or platform for data management and analytics. For example, the DMAP system may include one or more devices that train and run the ML model. The DMAP system may send results (such as outputs 1014) of the ML model to a wireless network to update one or more network entities 105 according to the results of the ML model. Additionally, or alternatively, one or more devices may use combined network parameters associated with network performance and DMAP performance to configure (such as auto-configure) a wireless communication network, such as in accordance with supporting a device-level network performance matrix.

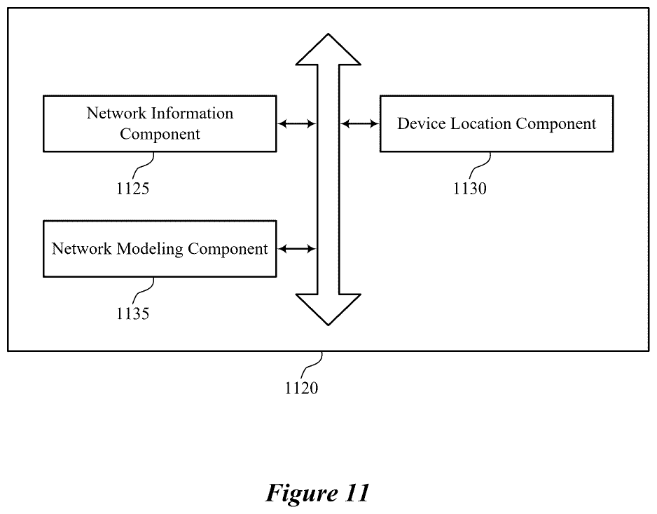

FIG. 11 shows an example of a processing system 1120 that supports a device-level network performance matrix. A processing system 1120 may be an example of a processing system of a device that generates the device-level network performance matrix (such as the server device 405 or the server device 705) and may include a network information component 1125, a device location component 1130, a network modeling component 1135, or any combination thereof. A processing system 1120, or various component thereof, may be an example of means for performing (such as a means for causing a network entity 105 to perform) various techniques described herein.

The network information component 1125 may be configured to cause the network entity 105 to obtain network information associated with a set of multiple devices within a wireless communication network, where the network information indicates a respective set of RSRP metrics and a respective set of interference metrics for each geographic area of a set of multiple geographic areas associated with the wireless communication network. The device location component 1130 may be configured to cause the network entity 105 to obtain device location information associated with the set of multiple devices within the wireless communication network, where the device location information indicates a respective quantity of devices within each geographic area of the set of multiple geographic areas. The network modeling component 1135 may be configured to cause the network entity 105 to output a set of parameters in accordance with the network information and the device location information.

In some implementations, a first portion of the network information indicates the respective set of RSRP metrics for each geographic area of the set of multiple geographic areas and is obtained from a first information source. In some implementations, a second portion of the network information indicates the respective set of interference metrics for each geographic area of the set of multiple geographic areas and is obtained from a second information source.

In some implementations, the respective set of RSRP metrics for each geographic area of the set of multiple geographic areas is constant within a periodic cycle associated with the wireless communication network. In some implementations, the respective set of interference metrics for each geographic area of the set of multiple geographic areas is variable within the periodic cycle associated with the wireless communication network. In some implementations, the respective quantity of devices within each geographic area of the set of multiple geographic areas is variable within the periodic cycle associated with the wireless communication network.

In some implementations, the respective set of interference metrics for each geographic area of the set of multiple geographic areas is variable within the periodic cycle in accordance with a variable traffic load at each interference source of a respective set of interference sources for that geographic area.

In some implementations, the respective quantity of devices within each geographic area of the set of multiple geographic areas is variable within the periodic cycle in accordance with a mobility of the set of multiple devices within the wireless communication network.

In some implementations, the periodic cycle associated with the wireless communication network includes a daily cycle, a weekly cycle, a monthly cycle, or a yearly cycle.

In some implementations, each geographic area of the set of multiple geographic areas is associated with a respective set of interference sources. In some implementations, each interference source of the respective set of interference sources is associated with a respective interference metric of the respective set of interference metrics.

In some implementations, the set of parameters is further in accordance with a respective contribution by each interference source of the respective set of interference sources for each geographic area to an overall interference metric associated with that geographic area.

In some implementations, the respective contribution by each interference source is a full contribution or a partial contribution in accordance with whether that interference source satisfies a condition. In some implementations, the full contribution or the partial contribution is relative to a transmission power by that interference source.

In some implementations, the condition is satisfied in accordance with an interference source using a same set of reference signal tones as a serving cell for that geographic area. In some implementations, the condition being satisfied is associated with the full contribution.

In some implementations, the condition is not satisfied in accordance with an interference source using a first set of reference signal tones different than a second set of reference signal tones used by a serving cell for that geographic area. In some implementations, the condition being not satisfied is associated with the partial contribution.

In some implementations, the partial contribution is associated with a product of the transmission power by that interference source and a multiplier value. In some implementations, the multiplier value is associated with a traffic load at that interference source and one or more transmission power parameters at that interference source.

In some implementations, the respective set of RSRP metrics for each geographic area of the set of multiple geographic areas includes a first RSRP metric associated with a serving cell for that geographic area and includes a set of additional RSRP metrics associated with a respective set of interference sources for that geographic area.

In some implementations, the respective set of interference sources includes a set of interfering cells associated with that geographic area.

In some implementations, the set of parameters includes a respective validity indication for each geographic area of the set of multiple geographic areas.

In some implementations, the respective validity indication for each geographic area of the set of multiple geographic areas indicates whether that geographic area is valid for an evaluation of the wireless communication network associated with one or more network configuration changes, invalid for the evaluation of the wireless communication network associated with the one or more network configuration changes, or absent of data.

In some implementations, the network information includes a first matrix of RSRP metrics associated with the set of multiple geographic areas and includes a second matrix of interference metrics associated with the set of multiple geographic areas. In some implementations, the first matrix of RSRP metrics indicates the respective set of RSRP metrics for each geographic area of the set of multiple geographic areas. In some implementations, the second matrix of interference metrics indicates the respective set of interference metrics for each geographic area of the set of multiple geographic areas.

In some implementations, the set of multiple geographic areas is associated with a three-dimensional virtual representation of the wireless communication network.

In some implementations, the set of parameters is associated with a model of the wireless communication network. In some implementations, the model is associated with an evaluation of the wireless communication network on a per geographic area basis in accordance with the respective set of RSRP metrics for each geographic area, the respective set of interference metrics for each geographic area, and the respective quantity of devices within each geographic area of the set of multiple geographic areas.

In some implementations, the evaluation of the wireless communication network on the per geographic area basis includes a calculation of a respective performance indicator metric (such as SINR, CQI, RSRQ, BLER, or packet loss) for each geographic area of the set of multiple geographic areas.

In some implementations, the respective performance indicator metric for each geographic area of the set of multiple geographic areas is associated with a respective throughput for that geographic area.

In some implementations, the respective set of RSRP metrics, the respective performance indicator metric, and the respective throughput for each geographic area of the set of multiple geographic areas are indicative of a user experience within that geographic area.

In some implementations, the evaluation of the wireless communication network on the per geographic area basis includes a prediction of a user experience impact from one or more network configuration changes to the wireless communication network.

A processing system 1120 may include or be an example of one or more chips, SoCs, chipsets, packages, components, or devices that individually or collectively constitute or include a processing system. A processing system 1120 may interface with other components of a network entity 105. For example, operations described with reference to a processing system 1120, or various components thereof, may be performed by or with other such components, including a receiver, a transmitter, a transceiver, a modem, a user interface, a modulator/demodulator, an encoder/decoder, or any combination thereof (such as of the processing system 1120, coupled with the processing system 1120, of a network entity 105). Operations described herein with reference to the processing system 1120, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

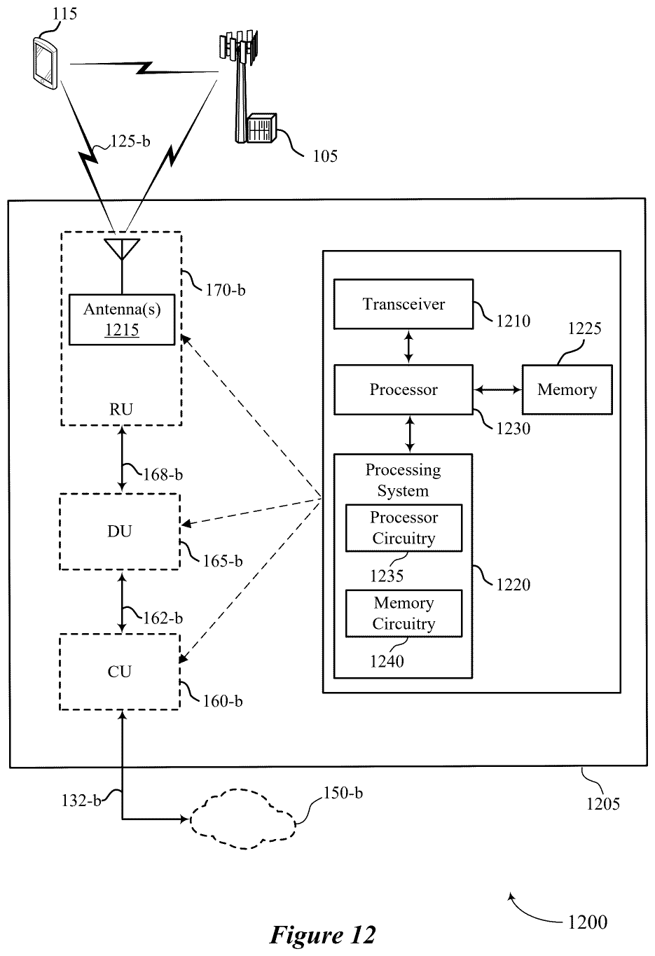

FIG. 12 shows an example of a system 1200 including a device 1205 that supports a device-level network performance matrix. The device 1205 may be an example of a device that generates the device-level network performance matrix, such as the server device 405 or the server device 705 as illustrated by and described with reference to FIGS. 4 and 7, respectively. The device 1205 may communicate (such as via one or more wired interfaces or one or more wireless interfaces) with other network devices or network equipment such as a core network 150-b, network entities 105, UEs 115, or any combination thereof. The device 1205 may include components for transmitting and receiving communication, which may include a processing system 1220, a transceiver 1210, antenna(s) 1215, a memory 1225, and a processor 1230. Components of the device 1205 may be coupled (such as operatively, communicatively, functionally, electronically, electrically, in electronic communication) via one or more interfaces.

The transceiver 1210 may communicate bi-directionally with another transceiver via wired or wireless links, and may support transmission operations, reception operations, or both, as described herein. The transceiver 1210 may include a modem to modulate and demodulate signals, to provide the modulated signals for transmission (such as via antenna(s) 1215, via a wired interface), and to demodulate received signals (such as received via antenna(s) 1215, received via a wired interface). The transceiver 1210 may be operable to support communication via one or more communication links (such as a communication link 125-b, a backhaul link 132-b, a midhaul link 162-b, fronthaul link 168-b).

The processor 1230 may be a general-purpose processing component that supports various operations (such as applications) of the device 1205. The memory 1225 may be a general-purpose storage component that stores code executable by the processor 1230. Such code may include instructions that, when executed by the processor 1230, cause the device 1205 to perform various functions (such as to support an application of the device 1205).

For examples in which the device 1205 is a network entity 105 in a disaggregated architecture, one or more components of the device 1205 may be located at one or more of a CU 160-b, a DU 165-b, or an RU 170-b, one or more of which may include aspects of the processing system 1220, the processor 1230, the memory 1225, or the transceiver 1210. Functions of the device 1205 may be performed at different components or an operation may be divided between different components (such as different functions being supported by aspects of the CU 160-b, the DU 165-b, or the RU 170-b, the transceiver 1210, the processor 1230, the memory 1225, the processing system 1220, or any combination thereof). For example, the processing system 1220 may be a component of one or more of the CU 160-b, the DU 165-b, or the RU 170-b. In some implementations, interfaces between components of device 1205 (such as CU 160-b, DU 165-b, RU 170-b) may support communication at a protocol layer or between protocol layers of a protocol stack.

In some implementations, the processing system 1220 may manage aspects of communication with the core network 150-b (such as via a backhaul link 132). For example, the processing system 1220 may manage the transfer of data communication for UEs 115 with a gateway of the core network 150-b. In some implementations, the processing system 1220 may manage communication with one or more other network entities 105 and may include a controller or scheduler for controlling communication with UEs 115 (such as in cooperation with the one or more other network entities 105). In some implementations, the processing system 1220 may support an interface (such as X2 interface, Xn interface) to provide communication between network entities 105.

The processing system 1220 may be an example of a processing system 145 or a processing system 1120. For example, the processing system 1220 may include processor circuitry 1235 and memory circuitry 1240 that stores code, and the processing system 1220 may be configured to cause the device 1205 to perform operations that support device-level network performance matrix. Although the processing system 1220 is illustrated as a separate component, which may involve a separate chip, chipset, or other module, in some implementations, one or more functions described with reference to the processing system 1220 may be supported by or performed by a transceiver 1210, antenna(s) 1215, a processor 1230, memory 1225, or any combination thereof, such that a processing system 1220 may include one or more of a transceiver 1210, antenna(s) 1215, a processor 1230, memory 1225, or any combination thereof. Further, processor circuitry 1235 and memory circuitry 1240 each may be implemented at the device 1205 in accordance with an aggregated architecture, or the processor circuitry 1235 and the memory circuitry 1240 may be implemented at one or more of a CU 160-b, a DU 165-b, or an RU 170-b in accordance with a disaggregated architecture.

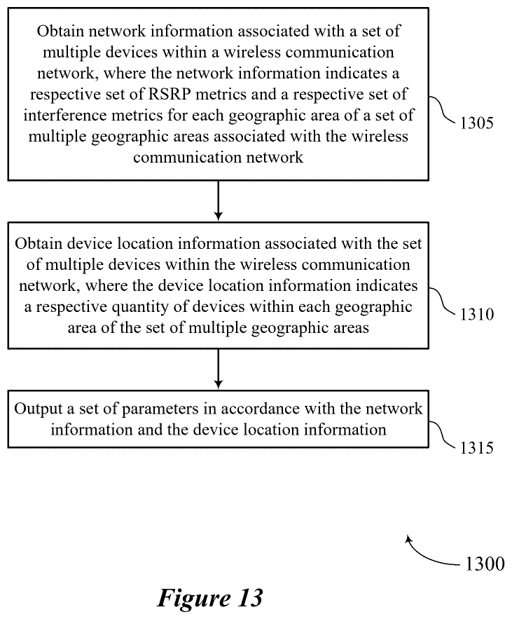

FIG. 13 shows an example of a method 1300 that supports a device-level network performance matrix. Operations of the method 1300 may be performed by a device that generates the device-level network performance matrix, such as the server device 405, the server device 705, or any other device (such as using a processing system configured to cause the device to perform one or more operations) as described herein.

At 1305, the method may include obtaining network information associated with a set of multiple devices within a wireless communication network, where the network information indicates a respective set of RSRP metrics and a respective set of interference metrics for each geographic area of a set of multiple geographic areas associated with the wireless communication network. In some implementations, aspects of the operations of 1305 may be performed by a network information component 1125.

At 1310, the method may include obtaining device location information associated with the set of multiple devices within the wireless communication network, where the device location information indicates a respective quantity of devices within each geographic area of the set of multiple geographic areas. In some implementations, aspects of the operations of 1310 may be performed by a device location component 1130.

At 1315, the method may include outputting a set of parameters in accordance with the network information and the device location information. In some implementations, aspects of the operations of 1315 may be performed by a network modeling component 1135.

Implementation examples are described in the following numbered aspects:
Aspect 1: A method for network communications, including: obtaining network information associated with a set of multiple devices within a wireless communication network, where the network information indicates a respective set of RSRP metrics and a respective set of interference metrics for each geographic area of a set of multiple geographic areas associated with the wireless communication network; obtaining device location information associated with the set of multiple devices within the wireless communication network, where the device location information indicates a respective quantity of devices within each geographic area of the set of multiple geographic areas; and outputting a set of parameters in accordance with the network information and the device location information.
Aspect 2: The method of aspect 1, where a first portion of the network information indicates the respective set of RSRP metrics for each geographic area of the set of multiple geographic areas and is obtained from a first information source, and a second portion of the network information indicates the respective set of interference metrics for each geographic area of the set of multiple geographic areas and is obtained from a second information source.
Aspect 3: The method of any of aspects 1-2, where the respective set of RSRP metrics for each geographic area of the set of multiple geographic areas is constant within a periodic cycle associated with the wireless communication network, the respective set of interference metrics for each geographic area of the set of multiple geographic areas is variable within the periodic cycle associated with the wireless communication network, and the respective quantity of devices within each geographic area of the set of multiple geographic areas is variable within the periodic cycle associated with the wireless communication network.
Aspect 4: The method of aspect 3, where the respective set of interference metrics for each geographic area of the set of multiple geographic areas is variable within the periodic cycle in accordance with a variable traffic load at each interference source of a respective set of interference sources for that geographic area.
Aspect 5: The method of any of aspects 3-4, where the respective quantity of devices within each geographic area of the set of multiple geographic areas is variable within the periodic cycle in accordance with a mobility of the set of multiple devices within the wireless communication network.
Aspect 6: The method of any of aspects 3-5, where the periodic cycle associated with the wireless communication network includes a daily cycle, a weekly cycle, a monthly cycle, or a yearly cycle.
Aspect 7: The method of any of aspects 1-6, where each geographic area of the set of multiple geographic areas is associated with a respective set of interference sources, and each interference source of the respective set of interference sources is associated with a respective interference metric of the respective set of interference metrics.
Aspect 8: The method of aspect 7, where the set of parameters is further in accordance with a respective contribution by each interference source of the respective set of interference sources for each geographic area to an overall interference metric associated with that geographic area.
Aspect 9: The method of aspect 8, where the respective contribution by each interference source is a full contribution or a partial contribution in accordance with whether that interference source satisfies a condition, and the full contribution or the partial contribution is relative to a transmission power by that interference source.
Aspect 10: The method of aspect 9, where the condition is satisfied in accordance an interference source using a same set of reference signal tones as a serving cell for that geographic area, and the condition being satisfied is associated with the full contribution.
Aspect 11: The method of any of aspects 9-10, where the condition is not satisfied in accordance with an interference source using a first set of reference signal tones different than a second set of reference signal tones used by a serving cell for that geographic area, and the condition being not satisfied is associated with the partial contribution.
Aspect 12: The method of any of aspects 9-11, where the partial contribution is associated with a product of the transmission power by that interference source and a multiplier value, and the multiplier value is associated with a traffic load at that interference source and one or more transmission power parameters at that interference source.
Aspect 13: The method of any of aspects 1-12, where the respective set of RSRP metrics for each geographic area of the set of multiple geographic areas includes a first RSRP metric associated with a serving cell for that geographic area and includes a set of additional RSRP metrics associated with a respective set of interference sources for that geographic area.
Aspect 14: The method of aspect 13, where the respective set of interference sources includes a set of interfering cells associated with that geographic area.
Aspect 15: The method of any of aspects 1-14, where the set of parameters includes a respective validity indication for each geographic area of the set of multiple geographic areas.
Aspect 16: The method of aspect 15, where the respective validity indication for each geographic area of the set of multiple geographic areas indicates whether that geographic area is valid for an evaluation of the wireless communication network associated with one or more configuration changes, invalid for the evaluation of the wireless communication network associated with the one or more configuration changes, or absent of data.
Aspect 17: The method of any of aspects 1-16, where the network information includes a first matrix of RSRP metrics associated with the set of multiple geographic areas and includes a second matrix of interference metrics associated with the set of multiple geographic areas, the first matrix of RSRP metrics indicates the respective set of RSRP metrics for each geographic area of the set of multiple geographic areas, and the second matrix of interference metrics indicates the respective set of interference metrics for each geographic area of the set of multiple geographic areas.
Aspect 18: The method of any of aspects 1-17, where the set of multiple geographic areas is associated with a three-dimensional virtual representation of the wireless communication network.
Aspect 19: The method of any of aspects 1-18, where the set of parameters is associated with a model of the wireless communication network, and the model is associated with an evaluation of the wireless communication network on a per geographic area basis in accordance with the respective set of RSRP metrics for each geographic area, the respective set of interference metrics for each geographic area, and the respective quantity of devices within each geographic area of the set of multiple geographic areas.
Aspect 20: The method of aspect 19, where the evaluation of the wireless communication network on the per geographic area basis includes a calculation of a respective performance indicator metric (such as SINR, CQI, RSRQ, BLER, or packet loss) for each geographic area of the set of multiple geographic areas.
Aspect 21: The method of aspect 20, where the respective performance indicator metric for each geographic area of the set of multiple geographic areas is associated with a respective throughput for that geographic area.
Aspect 22: The method of aspect 21, where the respective set of RSRP metrics, the respective performance indicator metric, and the respective throughput for each geographic area of the set of multiple geographic areas are indicative of a user experience within that geographic area.
Aspect 23: The method of any of aspects 19-22, where the evaluation of the wireless communication network on the per geographic area basis includes a prediction of a user experience impact from one or more configuration changes to the wireless communication network.
Aspect 24: A device, including: a processing system that includes processor circuitry and memory circuitry that stores code, the processing system configured to cause the device to: obtain network information associated with a set of multiple devices within a wireless communication network, where the network information indicates a respective set of RSRP metrics and a respective set of interference metrics for each geographic area of a set of multiple geographic areas associated with the wireless communication network; obtain device location information associated with the set of multiple devices within the wireless communication network, where the device location information indicates a respective quantity of devices within each geographic area of the set of multiple geographic areas; and output a set of parameters in accordance with the network information and the device location information.
Aspect 25: The device of aspect 24, where a first portion of the network information indicates the respective set of RSRP metrics for each geographic area of the set of multiple geographic areas and is obtained from a first information source, and a second portion of the network information indicates the respective set of interference metrics for each geographic area of the set of multiple geographic areas and is obtained from a second information source.
Aspect 26: The device of any of aspects 24-25, where the respective set of RSRP metrics for each geographic area of the set of multiple geographic areas is constant within a periodic cycle associated with the wireless communication network, the respective set of interference metrics for each geographic area of the set of multiple geographic areas is variable within the periodic cycle associated with the wireless communication network, and the respective quantity of devices within each geographic area of the set of multiple geographic areas is variable within the periodic cycle associated with the wireless communication network.
Aspect 27: The device of aspect 26, where the respective set of interference metrics for each geographic area of the set of multiple geographic areas is variable within the periodic cycle in accordance with a variable traffic load at each interference source of a respective set of interference sources for that geographic area.
Aspect 28: The device of any of aspects 26-27, where the respective quantity of devices within each geographic area of the set of multiple geographic areas is variable within the periodic cycle in accordance with a mobility of the set of multiple devices within the wireless communication network.
Aspect 29: The device of any of aspects 26-28, where the periodic cycle associated with the wireless communication network includes a daily cycle, a weekly cycle, a monthly cycle, or a yearly cycle.
Aspect 30: The device of any of aspects 24-29, where each geographic area of the set of multiple geographic areas is associated with a respective set of interference sources, and each interference source of the respective set of interference sources is associated with a respective interference metric of the respective set of interference metrics.
Aspect 31: The device of aspect 30, where the set of parameters is further in accordance with a respective contribution by each interference source of the respective set of interference sources for each geographic area to an overall interference metric associated with that geographic area.
Aspect 32: The device of aspect 31, where the respective contribution by each interference source is a full contribution or a partial contribution in accordance with whether that interference source satisfies a condition, and the full contribution or the partial contribution is relative to a transmission power by that interference source.
Aspect 33: The device of aspect 32, where the condition is satisfied in accordance an interference source using a same set of reference signal tones as a serving cell for that geographic area, and the condition being satisfied is associated with the full contribution.
Aspect 34: The device of any of aspects 32-33, where the condition is not satisfied in accordance with an interference source using a first set of reference signal tones different than a second set of reference signal tones used by a serving cell for that geographic area, and the condition being not satisfied is associated with the partial contribution.
Aspect 35: The device of any of aspects 32-34, where the partial contribution is associated with a product of the transmission power by that interference source and a multiplier value, and the multiplier value is associated with a traffic load at that interference source and one or more transmission power parameters at that interference source.
Aspect 36: The device of any of aspects 24-35, where the respective set of RSRP metrics for each geographic area of the set of multiple geographic areas includes a first RSRP metric associated with a serving cell for that geographic area and includes a set of additional RSRP metrics associated with a respective set of interference sources for that geographic area.
Aspect 37: The device of aspect 36, where the respective set of interference sources includes a set of interfering cells associated with that geographic area.
Aspect 38: The device of any of aspects 24-37, where the set of parameters includes a respective validity indication for each geographic area of the set of multiple geographic areas.
Aspect 39: The device of aspect 38, where the respective validity indication for each geographic area of the set of multiple geographic areas indicates whether that geographic area is valid for an evaluation of the wireless communication network associated with one or more configuration changes, invalid for the evaluation of the wireless communication network associated with the one or more configuration changes, or absent of data.
Aspect 40: The device of any of aspects 24-39, where the network information includes a first matrix of RSRP metrics associated with the set of multiple geographic areas and includes a second matrix of interference metrics associated with the set of multiple geographic areas, the first matrix of RSRP metrics indicates the respective set of RSRP metrics for each geographic area of the set of multiple geographic areas, and the second matrix of interference metrics indicates the respective set of interference metrics for each geographic area of the set of multiple geographic areas.
Aspect 41: The device of any of aspects 24-40, where the set of multiple geographic areas is associated with a three-dimensional virtual representation of the wireless communication network.
Aspect 42: The device of any of aspects 24-41, where the set of parameters is associated with a model of the wireless communication network, and the model is associated with an evaluation of the wireless communication network on a per geographic area basis in accordance with the respective set of RSRP metrics for each geographic area, the respective set of interference metrics for each geographic area, and the respective quantity of devices within each geographic area of the set of multiple geographic areas.
Aspect 43: The device of aspect 42, where the evaluation of the wireless communication network on the per geographic area basis includes a calculation of a respective performance indicator metric (such as SINR, CQI, RSRQ, BLER, or packet loss) for each geographic area of the set of multiple geographic areas.
Aspect 44: The device of aspect 43, where the respective performance indicator metric for each geographic area of the set of multiple geographic areas is associated with a respective throughput for that geographic area.
Aspect 45: The device of aspect 44, where the respective set of RSRP metrics, the respective performance indicator metric, and the respective throughput for each geographic area of the set of multiple geographic areas are indicative of a user experience within that geographic area.
Aspect 46: The device of any of aspects 42-45, where the evaluation of the wireless communication network on the per geographic area basis includes a prediction of a user experience impact from one or more configuration changes to the wireless communication network.
Aspect 47: A device, including: means for obtaining network information associated with a set of multiple devices within a wireless communication network, where the network information indicates a respective set of RSRP metrics and a respective set of interference metrics for each geographic area of a set of multiple geographic areas associated with the wireless communication network; means for obtaining device location information associated with the set of multiple devices within the wireless communication network, where the device location information indicates a respective quantity of devices within each geographic area of the set of multiple geographic areas; and means for outputting a set of parameters in accordance with the network information and the device location information.
Aspect 48: The device of aspect 47, where a first portion of the network information indicates the respective set of RSRP metrics for each geographic area of the set of multiple geographic areas and is obtained from a first information source, and a second portion of the network information indicates the respective set of interference metrics for each geographic area of the set of multiple geographic areas and is obtained from a second information source.
Aspect 49: The device of any of aspects 47-48, where the respective set of RSRP metrics for each geographic area of the set of multiple geographic areas is constant within a periodic cycle associated with the wireless communication network, the respective set of interference metrics for each geographic area of the set of multiple geographic areas is variable within the periodic cycle associated with the wireless communication network, and the respective quantity of devices within each geographic area of the set of multiple geographic areas is variable within the periodic cycle associated with the wireless communication network.
Aspect 50: The device of aspect 49, where the respective set of interference metrics for each geographic area of the set of multiple geographic areas is variable within the periodic cycle in accordance with a variable traffic load at each interference source of a respective set of interference sources for that geographic area.
Aspect 51: The device of any of aspects 49-50, where the respective quantity of devices within each geographic area of the set of multiple geographic areas is variable within the periodic cycle in accordance with a mobility of the set of multiple devices within the wireless communication network.
Aspect 52: The device of any of aspects 49-51, where the periodic cycle associated with the wireless communication network includes a daily cycle, a weekly cycle, a monthly cycle, or a yearly cycle.
Aspect 53: The device of any of aspects 47-52, where each geographic area of the set of multiple geographic areas is associated with a respective set of interference sources, and each interference source of the respective set of interference sources is associated with a respective interference metric of the respective set of interference metrics.
Aspect 54: The device of aspect 53, where the set of parameters is further in accordance with a respective contribution by each interference source of the respective set of interference sources for each geographic area to an overall interference metric associated with that geographic area.
Aspect 55: The device of aspect 54, where the respective contribution by each interference source is a full contribution or a partial contribution in accordance with whether that interference source satisfies a condition, and the full contribution or the partial contribution is relative to a transmission power by that interference source.
Aspect 56: The device of aspect 55, where the condition is satisfied in accordance an interference source using a same set of reference signal tones as a serving cell for that geographic area, and the condition being satisfied is associated with the full contribution.
Aspect 57: The device of any of aspects 55-56, where the condition is not satisfied in accordance with an interference source using a first set of reference signal tones different than a second set of reference signal tones used by a serving cell for that geographic area, and the condition being not satisfied is associated with the partial contribution.
Aspect 58: The device of any of aspects 55-57, where the partial contribution is associated with a product of the transmission power by that interference source and a multiplier value, and the multiplier value is associated with a traffic load at that interference source and one or more transmission power parameters at that interference source.
Aspect 59: The device of any of aspects 47-58, where the respective set of RSRP metrics for each geographic area of the set of multiple geographic areas includes a first RSRP metric associated with a serving cell for that geographic area and includes a set of additional RSRP metrics associated with a respective set of interference sources for that geographic area.
Aspect 60: The device of aspect 59, where the respective set of interference sources includes a set of interfering cells associated with that geographic area.
Aspect 61: The device of any of aspects 47-60, where the set of parameters includes a respective validity indication for each geographic area of the set of multiple geographic areas.
Aspect 62: The device of aspect 61, where the respective validity indication for each geographic area of the set of multiple geographic areas indicates whether that geographic area is valid for an evaluation of the wireless communication network associated with one or more configuration changes, invalid for the evaluation of the wireless communication network associated with the one or more configuration changes, or absent of data.
Aspect 63: The device of any of aspects 47-62, where the network information includes a first matrix of RSRP metrics associated with the set of multiple geographic areas and includes a second matrix of interference metrics associated with the set of multiple geographic areas, the first matrix of RSRP metrics indicates the respective set of RSRP metrics for each geographic area of the set of multiple geographic areas, and the second matrix of interference metrics indicates the respective set of interference metrics for each geographic area of the set of multiple geographic areas.
Aspect 64: The device of any of aspects 47-63, where the set of multiple geographic areas is associated with a three-dimensional virtual representation of the wireless communication network.
Aspect 65: The device of any of aspects 47-64, where the set of parameters is associated with a model of the wireless communication network, and the model is associated with an evaluation of the wireless communication network on a per geographic area basis in accordance with the respective set of RSRP metrics for each geographic area, the respective set of interference metrics for each geographic area, and the respective quantity of devices within each geographic area of the set of multiple geographic areas.
Aspect 66: The device of aspect 65, where the evaluation of the wireless communication network on the per geographic area basis includes a calculation of a respective performance indicator metric (such as SINR, CQI, RSRQ, BLER, or packet loss) for each geographic area of the set of multiple geographic areas.
Aspect 67: The device of aspect 66, where the respective performance indicator metric for each geographic area of the set of multiple geographic areas is associated with a respective throughput for that geographic area.
Aspect 68: The device of aspect 67, where the respective set of RSRP metrics, the respective performance indicator metric, and the respective throughput for each geographic area of the set of multiple geographic areas are indicative of a user experience within that geographic area.
Aspect 69: The device of any of aspects 65-68, where the evaluation of the wireless communication network on the per geographic area basis includes a prediction of a user experience impact from one or more configuration changes to the wireless communication network.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication networks such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other implementations, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some implementations, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some implementations, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some implementations, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series. For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and features disclosed herein.

What is claimed is:

1. A device, comprising:
a processing system that includes processor circuitry and memory circuitry that stores code, the processing system configured to cause the device to:
obtain network information associated with a plurality of devices within a wireless communication network, wherein the network information indicates a respective set of reference signal received power (RSRP) metrics and a respective set of interference metrics for each geographic area of a plurality of geographic areas associated with the wireless communication network;
obtain device location information associated with the plurality of devices within the wireless communication network, wherein the device location information indicates a respective quantity of devices within each geographic area of the plurality of geographic areas; and
output a set of parameters in accordance with the network information and the device location information.

2. The device of claim 1, wherein:
a first portion of the network information indicates the respective set of RSRP metrics for each geographic area of the plurality of geographic areas and is obtained from a first information source, and
a second portion of the network information indicates the respective set of interference metrics for each geographic area of the plurality of geographic areas and is obtained from a second information source.

3. The device of claim 1, wherein:
the respective set of RSRP metrics for each geographic area of the plurality of geographic areas is constant within a periodic cycle associated with the wireless communication network,
the respective set of interference metrics for each geographic area of the plurality of geographic areas is variable within the periodic cycle associated with the wireless communication network, and
the respective quantity of devices within each geographic area of the plurality of geographic areas is variable within the periodic cycle associated with the wireless communication network.

4. The device of claim 3, wherein the respective set of interference metrics for each geographic area of the plurality of geographic areas is variable within the periodic cycle in accordance with a variable traffic load at each interference source of a respective set of interference sources for that geographic area.

5. The device of claim 3, wherein the respective quantity of devices within each geographic area of the plurality of geographic areas is variable within the periodic cycle in accordance with a mobility of the plurality of devices within the wireless communication network.

6. The device of claim 3, wherein the periodic cycle associated with the wireless communication network comprises a daily cycle, a weekly cycle, a monthly cycle, or a yearly cycle.

7. The device of claim 1, wherein:
each geographic area of the plurality of geographic areas is associated with a respective set of interference sources, and
each interference source of the respective set of interference sources is associated with a respective interference metric of the respective set of interference metrics.

8. The device of claim 7, wherein the set of parameters is further in accordance with a respective contribution by each interference source of the respective set of interference sources for each geographic area to an overall interference metric associated with that geographic area.

9. The device of claim 8, wherein:
the respective contribution by each interference source is a full contribution or a partial contribution in accordance with whether that interference source satisfies a condition, and
the full contribution or the partial contribution is relative to a transmission power by that interference source.

10. The device of claim 9, wherein:
the condition is satisfied in accordance with an interference source using a same set of reference signal tones as a serving cell for that geographic area, and
the condition being satisfied is associated with the full contribution.

11. The device of claim 9, wherein:
the condition is not satisfied in accordance with an interference source using a first set of reference signal tones different than a second set of reference signal tones used by a serving cell for that geographic area, and
the condition being not satisfied is associated with the partial contribution.

12. The device of claim 9, wherein:
the partial contribution is associated with a product of the transmission power by that interference source and a multiplier value, and
the multiplier value is associated with a traffic load at that interference source and one or more transmission power parameters at that interference source.

13. A method for network communications, comprising:
obtaining network information associated with a plurality of devices within a wireless communication network, wherein the network information indicates a respective set of reference signal received power (RSRP) metrics and a respective set of interference metrics for each geographic area of a plurality of geographic areas associated with the wireless communication network;
obtaining device location information associated with the plurality of devices within the wireless communication network, wherein the device location information indicates a respective quantity of devices within each geographic area of the plurality of geographic areas; and
outputting a set of parameters in accordance with the network information and the device location information.

14. The method of claim 13, wherein the respective set of RSRP metrics for each geographic area of the plurality of geographic areas comprises a first RSRP metric associated with a serving cell for that geographic area and comprises a set of additional RSRP metrics associated with a respective set of interference sources for that geographic area, and wherein the respective set of interference sources comprises a set of interfering cells associated with that geographic area.

15. The method of claim 13, wherein the set of parameters comprises a respective validity indication for each geographic area of the plurality of geographic areas, and wherein the respective validity indication for each geographic area of the plurality of geographic areas indicates whether that geographic area is:
valid for an evaluation of the wireless communication network associated with one or more network configuration changes,
invalid for the evaluation of the wireless communication network associated with the one or more network configuration changes, or
absent of data.

16. The method of claim 13, wherein:
the network information comprises a first matrix of RSRP metrics associated with the plurality of geographic areas and comprises a second matrix of interference metrics associated with the plurality of geographic areas,
the first matrix of RSRP metrics indicates the respective set of RSRP metrics for each geographic area of the plurality of geographic areas, and
the second matrix of interference metrics indicates the respective set of interference metrics for each geographic area of the plurality of geographic areas.

17. The method of claim 13, wherein the plurality of geographic areas is associated with a three-dimensional virtual representation of the wireless communication network.

18. The method of claim 13, wherein:
the set of parameters is associated with a model of the wireless communication network, and
the model is associated with an evaluation of the wireless communication network on a per geographic area basis in accordance with the respective set of RSRP metrics for each geographic area, the respective set of interference metrics for each geographic area, and the respective quantity of devices within each geographic area of the plurality of geographic areas.

19. The method of claim 18, wherein:
the evaluation of the wireless communication network on the per geographic area basis comprises a calculation of a respective performance indicator metric for each geographic area of the plurality of geographic areas;
the respective performance indicator metric for each geographic area of the plurality of geographic areas is associated with a respective throughput for that geographic area; and
the respective set of RSRP metrics, the respective performance indicator metric, and the respective throughput for each geographic area of the plurality of geographic areas are indicative of a user experience within that geographic area.

20. The method of claim 18, wherein the evaluation of the wireless communication network on the per geographic area basis comprises a prediction of a user experience impact from one or more network configuration changes to the wireless communication network.
